(19) United States
(12) Patent Application Publication
(10) Pub. No.: US 2005/0191441 A1
(43) Pub. Date: Sep. 1, 2005

(54) Ink jet recording medium

(75) Inventors: Hiroshi Yamamoto, Shizuoka-ken (JP); Shinichi Teramae, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/067,226

(22) Filed: Feb. 28, 2005

(30) Foreign Application Priority Data
Mar. 1, 2004 (JP) 2004-056610

(51) Int. Cl. B41M 5/00

(52) U.S. Cl. 428/32.24

(57) ABSTRACT

Disclosed is an ink jet recording medium comprising at least both an ink receiving layer and a gloss imparting layer in this order on the support of the ink jet recording medium; the gloss imparting layer features the inclusion of a superfine particle inorganic compound having a refractive index of at least 1.9 and an average particle diameter of 100 nm or less, a water-soluble resin, and a crosslinking agent capable of crosslinking the water-soluble resin.

### CROSS-REFERENCE TO RELATED APPLICATIONS

This application claims priority under 35 USC 119 from Japanese patent application No. 2004-056610, the disclosure of which is incorporated by reference herein.

### BACKGROUND OF THE INVENTION

1. Field of the Invention

The present invention relates to an ink jet recording medium having printing properties suitable for ink jet recording which employs liquid inks such as aqueous and oil-based inks or solid inks which are solid at room temperature and used for printing images in the fused and fluidized state.

2. Description of the Related Art

With the recent rapid progress of the communication industry, various information processing systems have been developed and various recording methods and devices suitable for use in these information processing systems have also been developed and already in use. Among the recording methods above, ink jet recording method has been widely used not only in offices but also in homes, as the ink jet method allows printing on various recording materials and the hardware (devices) thereof is relatively low-cost, more compact, and more silent.

In addition, with the recent trend of ink jet printers toward higher-resolution and in the progress of the hardware (devices), diverse medium for ink jet recording has been developed. More recently, some ink jet printers allow printing of so-called photorealistic high-quality images. Properties required especially for the ink jet recording medium include in general, (1) quick drying property (high ink-absorbing rate), (2) suitable and uniform diameter of ink dots (absence of ink bleeding), (3) favorable graininess, (4) high circularity of printed dots, (5) high color density, (6) higher chroma saturation (absence of dullness), (7) favorable light fastness, gas resistance, and water resistance of printed image portions, (8) higher whiteness of recording surface, (9) favorable storage stability of recording medium (absence of yellowing and image bleeding over an extended period of time), (10) deformation resistance and favorable dimensional stability (suppressed curling), (11) favorable traveling characteristics through a machine, and the like. In addition, for application as photographic glossy papers, which are used for printing so-called photorealistic high-quality images, glossiness, surface smoothness, the silver halide photographic printing paper-like touch, and the like are also demanded in addition to the properties above.

There presently exist ink jet recording sheets which contain fine inorganic pigment particles and water-soluble resins, and which have a support on which porous color material receiving layers of high porosities are disposed (e.g., see Japanese Patent Application Laid-Open (JP-A) Nos. 10-119423 and 10-217601). These recording sheets, particularly those having color material receiving layers with porous structures that make use of silica as inorganic pigment particulates, exhibit excellent ink absorption due to their structures, have high ink-receiving performance enabling formation of high resolution images, and also exhibit high gloss.

In order to provide ink jet recording medium superior in glossiness, planarity, and image quality, resin-coated papers laminated with a polyethylene resin on both faces of a paper base support have hitherto been commonly used as the support for the ink jet recording medium. However, the resin-coated papers do not absorb ink solvents contained in such inks. Accordingly, when used as the support, the resin-coated papers carried the problem of image bleeding over time, as the ink solvents do not evaporate sufficiently fast when the medium are stored in files immediately after printing.

It may be conceived that an ink jet recording medium may constitute of a support not having a resin film to prevent image bleeding. However, if an absorbing support such as a currently available paper substrate has an ink receiving layer, provided directly thereon bleeding with time is decreased due to the absorption of an ink medium, which, however, poses the problem of a marked decrease in surface glossiness.

In this regard, an ink jet recording medium has been proposed that is provided with a thermoplastic latex-based gloss layer on the surface of its ink receiving layer (see JP-A No.2000-177240). However, while the ink jet recording medium, has improved glossiness owing to the gloss layer, it requires that a print recording material be obtained by first conducting ink jet recording, and then coating with a latex layer by the pressurization and heat application of a pair of rubber rollers. The resultant problem is that a general purpose ink jet printer is unable to obtain gloss.

Currently, there are no ink jet recording medium having the glossiness, high planarity, and high-quality image forming ability at the same level as the case where the resin-coated papers are used as the support and at the same time having a high ink solvent absorptive property and thus suppressing the image bleeding with time.

### SUMMARY OF THE INVENTION

A first aspect of the invention is to provide an ink jet recording medium comprising at least both an ink receiving layer and a gloss imparting layer in this order on the support of the ink jet recording medium; the gloss imparting layer features the inclusion of an superfine particle inorganic compound having a refractive index of at least 1.9 and an average particle diameter of 100 nm or less, a water-soluble resin, and a crosslinking agent capable of crosslinking the water-soluble resin.

A second aspect of the invention is to provide an ink jet recording medium comprising at least an ink receiving layer and a gloss imparting layer in this order on a support comprising a paper substrate and an ink solvent permeable undercoat layer of 2 to 20 g/cm² formed at least on the formation face side of the ink receiving layer of the paper substrate through the use of a dispersing solution containing therein a thermoplastic resin and a white pigment; the gloss imparting layer features the inclusion of a superfine particle inorganic compound having a refractive index of at least 1.9 and an average particle diameter of 100 nm or less, a water-soluble resin, and a crosslinking agent capable of crosslinking the water-soluble resin.

### DETAILED DESCRIPTION OF THE INVENTION

According to the invention, can be provided an ink jet recording medium that is excellent in flatness properties, has good ink absorption, can form a high quality image, is particularly high in grossness, and can additionally restrain the generation of bleeding with time of the image formed.

<Ink Jet Recording Medium>

An ink jet recording medium of the invention is an ink jet recording medium comprising at least an ink receiving layer and a gloss imparting layer in this order on the support of the ink jet recording medium; the gloss imparting layer features the inclusion of an superfine particle inorganic compound having a refractive index of at least 1.9 or more and an average particle diameter of 100 nm or less, a water-soluble resin, and a crosslinking agent capable of crosslinking the water-soluble resin.

Providing a gloss imparting layer on an ink-receiving layer, an ink jet recording medium of the invention can enhance the glossiness of an image recording face while maintaining in excellent conditions the flatness properties of the surface (hereinafter, may be called the “image recording face”) of the side on which the ink receiving layer is disposed. This makes it possible to form a high glossiness image, for example, even when a resin coating paper or the like is not used as a support. Also, an ink jet recording medium of the invention can enhance the glossiness of a formed image without the use of a resin coating paper as a support as described above and thus can use a support having ink absorption such as a paper substrate. This can prevent the generation of image bleeding (bleeding with time).

An ink jet recording medium of the invention comprises an ink receiving layer and a gloss imparting layer on the support of the ink jet recording medium. Also, the recording medium may further have other layers as necessary.

(Gloss Imparting Layer)

A gloss imparting layer of the invention comprises an superfine particle inorganic compound having a refractive index of at least 1.9 or more and an average particle diameter of 100 nm or less, a water-soluble resin, and a crosslinking agent. A gloss imparting layer is placed at least on the image recording face side rather than on the ink receiving layer, is preferably the outermost layer on the image recording face side.

Examples of the “superfine particle inorganic compound having a refractive index of 1.9 or more and an average particle diameter of 100 nm or less” include a rutile type titanium dioxide, an anatase type titanium dioxide, zirconia, zinc oxide, zinc sulfide, and the like, preferably titanium dioxides such as a rutile type titanium dioxide and an anatase type titanium dioxide (superfine particle titanium dioxides) and zirconia (superfine particle zirconia). The refractive index of the superfine particle inorganic compound is preferably 2.0 or more; the outer limit is preferably 3.0 or less. The average particle diameter of the superfine particle inorganic compound is preferably 80 nm or less, more preferably 60 nm or less. The lower limit of the average particle diameter of the superfine particle inorganic compound is not particularly limited, and is preferably 5 nm or more. The term “average particle diameter” stands for the particle diameter of an area average; by consideration of a circle equivalent to the projected area of each particle as the diameter of the particle, it is the number average of the diameters of the particles.

The thickness of a gloss imparting layer of the invention is preferably from 0.1 to 2 μm, from the viewpoint of the prevention of the fact that the agglomeration of ink called beading in a color overlap portion due to a decrease in ink absorbing capability is generated on the surface of the ink jet recording medium, thereby deteriorating image recording properties, more preferably from 0.1 to 0.5 μm.

The amount of application of the superfine particle inorganic compound in a gloss imparting layer of the invention is preferably from 0.1 to 2 g/m², from the standpoint of enhancement of ink absorption, more preferably from 0.5 to 1.5 g/m².

The content of superfine particle inorganic compound in the gloss imparting layer of the invention is preferably from 5 to 95% by mass, from the viewpoints of the enhancement of layer strength, the prevention of layer cracking, powder falling, etc, and also the enhancement of ink absorption, more preferably from 15 to 40% by mass.

Superfine Particle Titanium Dioxide

As described above, the superfine particle inorganic compound is preferably a superfine particle titanium dioxide. Herein, “superfine particle titanium dioxide” means titanium dioxide having an average particle diameter of 100 nm or less. In other words, superfine particle titanium dioxide is a superfine particle that differs from a pigment conventionally called “titanium white”; the primary particle diameter is more than one order of magnitude smaller than that of titanium white. This restrains light scattering, renders the transparency high and the ultraviolet-ray absorption capability substantially high. Hereafter, superfine particle titanium dioxide is simply called “titanium dioxide” in some cases.

The average particle diameter of the above titanium dioxide is preferably 20 nm or less, from the standpoints of the improvement of image by restraint of haze and the enhancement of ink absorption, more preferably 15 nm or less, most preferably 10 nm or less. An “average particle diameter” stands for the particle diameter of the area average as described above; by consideration of a circle equivalent to the projected area of each particle as the diameter of the particle, it is the number average of the diameters of the particles. The particle diameter distribution of the above titanium dioxide is preferably monodispersed, is 20% or less in terms of the coefficient of variation (standard deviation of the particle diameter distribution divided by the average particle diameter), preferably 15% or less, more preferably 10% or less.

The above titanium dioxide may be produced by treatment, including hydrolysis and gas phase oxidation, of a titanium salt. Also, the above titanium dioxide may have any one of the structures of the rutile type, the brookite type and the anatase type, and is more preferably of the rutile type from the standpoint of the reflectance of visible light.

The amount of application of the above titanium dioxide in a gloss imparting layer of the invention is preferably from 0.1 to 2 g/m², from the standpoint of the enhancement of ink absorption, more preferably from 0.5 to 1.5 g/m².

The content of titanium dioxide in the above gloss imparting layer is preferably from 5 to 95% by mass, from the standpoints of the enhancement of layer strength, the prevention of layer cracking, powder falling, etc. as well as the enhancement of ink absorption, more preferably from 15 to 40% by mass.

The above titanium dioxide may also be surface treated with an inorganic compound or an organic compound for the purpose of improvement of dispersibility and workability. The surface treatment and the surface treated titanium dioxide may use the methods and the compounds disclosed in, for example, JP-A Nos. 52-35625, 55-10865, 57-35855, 62-25753, 62-103635 and 9-050093. For the aforementioned surface treatment, the surface treating agents that may be preferably used include inorganic compounds such as aluminum oxide hydrate, water-containing zinc hydroxide and silicon dioxide; and organic compounds such as divalent to tetravalent alcohols, trimethylolamine, titanate coupling agents, and silane coupling agents. The amounts of use of these surface treating agents can be selected depending on their purposes. For instance, the amount of use of the above inorganic surface treating agent is generally in the range of about 3% by mass or less based on the amount of superfine particle titanium dioxide, preferably in the range of from 0.01 to 1% by mass. The amount of use of the above organic surface treating agent is generally in the range of about 5% by mass or less, preferably in the range of from 0.1 to 3% by mass.

Superfine Particle Zirconia

The above superfine particle inorganic compounds preferably include superfine particle zirconium dioxide. Herein, a “superfine particle zirconia” stands for zirconia having an average particle diameter of 100 nm or less. Here, “zirconia” means an oxide of zirconium having the chemical formula ZrO₂. Hereinafter, a superfine particle zirconia may simply be called “zirconia” in some cases.

The average particle diameter of the above zirconia is 100 nm or less, from the standpoints of improvement of image quality by restraint of haze and enhancement of ink absorption, preferably 80 nm or less. Here, an “average particle diameter” stands for the particle diameter of the area average as described above; by consideration of a circle equivalent to the projected area of each particle as the diameter of the particle, it is the number average of the diameters of the particles.

Examples of the above zirconia that may be used include a peptized substance; the process of producing the substance involves forming a precipitate in a mixture solution of zirconia propoxide, water and nitric acid, and then peptizing this precipitate with nitric acid. The above zirconias that may be used include acidic zirconias described in U.S. Pat. No. 2,984,628, and JP-A No. 58-79818, and a basic zirconia described in JP-A No. 8-277115. Also, examples of the zirconia that may be used include commercially available articles of NTS-30A, NZS-30B, NZS-20A (manufactured by Nissan Chemical Industries, Ltd.), and the like.

The amount of application of the above zirconia in a gloss imparting layer of the invention is preferably from 0.1 to 2 g/m², as in the above titanium dioxide, from the standpoint of the enhancement of ink absorption, more preferably from 0.5 to 1.5 g/m².

The content of zirconia in the above-described gloss imparting layer is preferably from 5 to 95% by mass, from the viewpoints of the enhancement of layer strength, the prevention of layer cracking and powder falling and also the enhancement of ink absorption, more preferably from 15 to 40% by mass.

Within the scope of not losing the efficacy of the invention, a gloss imparting layer of the invention may contain or disperse therein a white pigment as will be described below or the like, light reflecting substances such as normal titanium dioxide, aluminum oxide, zinc oxide, calcium carbonate and calcium sulfate, or pigment substances, in addition to the above superfine particle titanium dioxide or superfine particle zirconia. Because the above superfine particle titanium dioxide or the like is a relatively expensive material due to the special manufacturing process thereof, the use along with another pigment having a normal particle diameter is economically advantageous, as long as desired quality is ensured. When a superfine particle inorganic compound such as the above superfine particle titanium dioxide or superfine particle zirconia in the invention is used together with another pigment, the amount of use of the above superfine particle inorganic compound is preferably 30% by mass or more based on the total amount of pigment, more preferably 50% by mass or more.

Water-Soluble Resin

A gloss imparting layer in the invention contains a water-soluble resin. A water-soluble resin contained in a gloss imparting layer in the invention may use a material similar to a water-soluble resin used in an ink receiving layer as will described below.

Examples of the water-soluble resins used for the ink receiving layer include polyvinyl alcohol resins having a hydroxy group as the hydrophilic constitutional unit [polyvinyl alcohol (PVA), acetoacetyl-modified polyvinyl alcohol, cation-modified polyvinyl alcohol, anion-modified polyvinyl alcohol, silanol-modified polyvinyl alcohol, polyvinylacetal, etc.]; cellulosic resins [methylcellulose (MC), ethylcellulose (EC), hydroxyethylcellulose (HEC), carboxymethylcellulose (CMC), hydroxypropylcellulose (HPC), hydroxyethylmethylcellulose, hydroxypropylmethylcellulose, etc.]; chitins; chitosans; starch; ether bond-containing resins [polyethylene oxide (PEO), polypropylene oxide(PPO), polyethylene glycol (PEG), polyvinyl ether (PVE), etc.]; carbamoyl group-containing resins [polyacrylamide (PAAM), polyvinylpyrrolidone (PVP), polyacrylic acid hydrazide, etc.]; and the like. In addition, resins having a carboxyl group as the dissociative group, such as polyacrylate salts, maleic acid resins, and alginate salts; gelatins, and the like, are also included. The water-soluble resins may be used alone or in combination of two or more.

Of the above materials, water-soluble resins used in a gloss imparting layer in the invention particularly preferably include polyvinyl alcohol, from the standpoints of attainment of ink absorption and provision of the adhesiveness with the ink receiving layer.

The above polyvinyl alcohol is preferably polyvinyl alcohol having a degree of polymerization of from 300 to 4000, more preferably from 500 to 2500. The saponification percent of the polyvinyl alcohol is preferably 70 to 99.5%, more preferably from 80 to 99.5%.

Examples of the polyvinyl alcohol include those described in Japanese Patent Application Publication (JP-B) Nos. 4-52786, 5-67432, and 7-29479, Japanese Patent No. 2537827, JP-B No. 7-57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080, and 9-39373, Japanese Patent No. 2750433, JP-A Nos. 2000-158801, 2001-213045, 2001-328345, 8-324105, and 11-348417. Examples of water-soluble resins exclusive of polyvinyl alcohol-based resins include compounds described in [0011] to [0014] of JP-A No. 11-165461, and the like.

The above water-soluble resins may be used singly or in combination of two species or more.

Of these, specific examples of polyvinyl alcohols used in the above gloss imparting layer preferably include completely saponified polyvinyl alcohol, partially saponified polyvinyl alcohol, acetoacetyl modified polyvinyl alcohol, a cation modified polyvinyl alcohol, an anion modified polyvinyl alcohol, a silanol modified polyvinyl alcohol, a carboxyl group modified polyvinyl alcohol, an aromatic amino group modified polyvinyl alcohol, a thiol group modified polyvinyl alcohol, and a ketone group modified polyvinyl alcohol; more preferable polyvinyl alcohols include the same species as polyvinyl alcohols used in an ink receiving layer.

The content of the above water-soluble resin used in a gloss imparting layer in the invention is preferably from 5 to 95% by mass based on the total amount of solid components of the gloss imparting layer, from the standpoint of the prevention of powder falling and beading, more preferably from 10 to 90% by mass.

Crosslinking Agent

Preferably, a gloss imparting layer in the invention contains a crosslinking agent capable of crosslinking the above water-soluble resin and is a layer that is formed by crosslinking cure of the water-soluble resin. A crosslinking agent used in a gloss imparting layer in the invention can be selected as appropriate depending on the kind of water-soluble resin used in the gloss imparting layer, and can use, for example, the same crosslinking agent as that of an ink receiving layer as will be described below.

This croslinking agent is preferably boric acid or a boron compound in that crosslinking reaction is rapid. Examples of the above boron compound include borax, borate salts (e.g., orthoborate salts, InBO₃, ScBO₃, YBO₃, LaBO₃, Mg₃(BO₃)₂, Co₃(BO₃)₂), diborate salts (e.g., Mg₂B₂O₅, CO₂B₂O₅), metaborate salts (e.g., LiBO₂, Ca(BO₂)₂, NaBO₂, KBO₂), tetraborate salts (e.g., Na₂B₄O₇.10H₂O), pentaborate salts (e.g., KB₅O₈.4H₂O, CsB₅O₅), Ca₂B₆O₁₁.7H₂O, and the like.

Of these, borax, boric acid and borate salts are preferable in that crosslinking reaction is rapid, boric acid is more preferable, and the combination use of these and polyvinyl alcohols, i.e., water-soluble resins, is most preferable.

The content of crosslinking agent in a gloss imparting layer in the invention is preferably from 0.01 to 0.5 part by mass based on 1 part by mass of the water-soluble resin, more preferably from 0.05 to 0.1 part by mass. When the content of crosslinking agent is within the above range, the agent can effectively prevent cracking and the like by crosslinkage of a water-soluble resin.

The above crosslinking agent may also use compounds below in addition to boron and boron compounds. The examples include aldehyde-based compounds such as formaldehyde, glyoxal and glutaraldehyde; ketone-based compounds such as diacetyl and cyclopentanedione; active halogen compounds such as bis(2-chloroethyl urea)-2-hydroxy-4,6-dichloro-1,3,5-triazine, 2,4-dichloro-6-S-triazine·sodium salt; active vinyl compounds such as divinylsulfonic acid, 1,3-vinylsulfonyl-2-propanol, N,N′-ethylenebis(vinylsulfonylacetamide), and 1,3,5-triacryloyl-hexahydro-S-triazine; N-methylol compounds such as dimethylol urea and methyloldimethylhydantoin; melamine resins (e.g., methyllolmelamine, alkylated methyllolmelamines); epoxy resins; isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; epoxy compounds such as glycerol triglycidylether; ethylene imino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chrome alum, potassium alum, zirconyl acetate, and chromium acetate; polyamine compounds such as tetraethylene pentamine; hydrazide compounds such as adipic acid dihydrazide; low-molecular weight compounds or polymers having 2 or more oxazoline groups; and the like. The cross-linking agents may be used alone or in combination of two or more.

Although the above crosslinking agent may directly be added to a gloss imparting layer coating solution containing a superfine particle inorganic compound and a water-soluble resin when a gloss imparting layer is formed, the crosslinking agent is not directly added to a gloss imparting layer coating solution and may be indirectly added from the ink receiving layer as follows. In other words, after the ink receiving layer as will described below is applied and formed, a gloss imparting layer coating solution not containing a crosslinking agent is applied to the ink receiving layer surface and a gloss imparting layer is formed, whereby the crosslinking agent in the ink receiving layer is diffused to the gloss imparting layer. As such, even though a crosslinking agent is not directly added to a gloss imparting layer coating solution, a gloss imparting layer can be made to contain the crosslinking agent.

(Support)

Now, a support will be described. Although a support in the invention may use either a solvent unabsorbing support such as resin layer paper by application of a coating of a paper substrate with a resin layer containing a thermoplastic resin such as polyethylene, or a solvent absorbing support such as paper, the support having solvent adsorption is preferably used from the standpoint of effective suppression of the occurrence of bleeding with time.

### SUPPORT OF THE INVENTION

The supports having the above solvent absorption include base paper. The invention preferably uses a support (hereinafter, may be called a “support in the invention” constituting a paper substrate and an ink solvent permeable undercoat layer formed at least on the formation face side of an ink receiving layer of the paper substrate. The ink solvent permeable undercoat layer may be formed on the side on which at least the ink receiving layer of the paper substrate is formed, and can be placed on both sides of the paper substrate depending on the purpose and the like. As described above, the use of a support of the invention can effectively suppress the generation of bleeding with time.

The above ink solvent permeable undercoat layer is preferably formed with a dispersion solution containing thermoplastic resin particulates and a white pigment; the amount of application of the undercoat layer is preferably from 2 to 20 g/m², more preferably from 4 to 20 g/m². When the amount of application of the above undercoat layer is within the range of from 2 to 20 g/m², gloss can be imparted in the formation of an ink jet recording medium while the impregnation of an ink receiving layer coating solution with the above undercoat layer is suppressed, and also the coated face properties of the ink receiving layer can be improved. Furthermore, when the above amount of application is within the range of from 2 to 20 g/m², the permeability of an ink solvent becomes high, thereby being capable of improving the restraint effect of bleeding with time.

Next, the above-mentioned thermoplastic particulates and white pigment will be set forth.

The above thermoplastic resin particulates are not particularly limited, and well known thermoplastic resin particulates such as polyolefin resins (e.g., a single polymer of an α-olefin such as polyethylene or polypropylene, or a mixture thereof) and latex thereof can be as appropriate selected for use. Of these, the above thermoplastic resin particulates are preferably latexes; the examples can suitably include an acrylic latex, an acrylic silicone-based latex, an acrylic epoxy-based latex, an acrylic styrene-based latex, an acrylic urethane-based latex, a styrene-butadiene-based latex, an acrylonitrile-butadiene-based latex, a vinyl acetate-based latex, and the like. At least one species of these is preferably selected for use.

Examples of the above thermoplastic resin particulates are hybrid-type emulsion Aquabrid series products, manufactured by Daicel Chemical Industries, Ltd., (e.g., Aquabrid 903, ASi-86, ASi-91, 4635, 4901, MSi-04S, AU-124, AU-131, AEA-61, AEC-69, and AEC-162) and the like.

The thermoplastic resin fine particles may be used alone or in combination of two or more.

The glass transition temperature (Tg) of the above thermoplastic resin particulates is preferably from 5 to 70° C., more preferably from 15 to 70° C. When the Tg is within the range of from 5 to 70° C., the production of the resin particulates is readily handled since a solution (coating solution, etc.) for the formation of an ink solvent permeable undercoat layer does not cause problems such as skinning. Also, a desirable gloss is readily obtainable because there is no need for setting the calender temperature to be high; no disadvantages such as deterioration of the surface are suffered since the adhesion of the particulates to the metal roll surface rarely occurs.

The lowest temperature for layer formation of the aforementioned thermoplastic resin particulates is preferably from 5 to 60° C., more preferably from 15 to 60° C. When a thermoplastic resin is used that has the aforementioned lowest temperature range for layer formation of from 5 to 60° C., the production of the resin particulates is readily handled since a solution (coating solution, etc.) for the formation of an ink solvent permeable undercoat layer does not cause problems such as skinning, and also penetration can be restrained when the ink receiving layer as will be described below is produced, whereby the coated face properties of the layer are not decreased as well; as a result, the construction of a layer having porous properties enough for an ink solvent to rapidly permeate can result.

The content of the above thermoplastic resin particulates in the aforementioned undercoat layer is preferably from 15 to 95% by mass based on the solid components of the above undercoat layer, more preferably from 30 to 90% by mass. When the above content is within the range of from 30 to 90% by mass, permeability of an ink solvent can be obtained without loss of gloss properties and flatness properties after calender treatment as will be described below, whereby the generation of bleeding with time can effectively be prevented.

The above white pigments include, for example, titanium oxide, barium sulfate, barium carbonate, calcium carbonate, lithopone, alumina white, zinc oxide, silica-doped antimony trioxide, titanium phosphate, and the like. These can be used singly or in a mixture of two or more species. Of these, titanium oxide is more preferable, in whiteness, dispersibility and stability.

The particle size of the white pigment is preferably from 0.1 to 0.5 μm. When the particle size of the above white pigment is within the range of from 0.1 to 5 μm, the whiteness and gloss properties can be made to be effectively improved.

The aforementioned titanium oxide may be any of the rutile type and the anataze type; these may be used singly or in a mixture. The above titanium oxide may be any one produced by the sulfuric acid process or the chlorine process. The above titanium oxide can be selected as appropriate from species subjected to surface coating treatments with inorganic substances such as a water-containing alumina treatment, a water-containing silicon dioxide-based treatment, and a zinc oxide treatment, species subjected to surface coating treatments with organic substances such as trimethylol methane, trimethylol ethane, trimethylol propane, and 2,4-dihydroxy-2-methylpentane, and species treated with siloxanes such as polydimethylsiloxane, and the like.

The refractive index of the white pigment is preferably 1.5 or more, more preferably 2.0 or more. The inclusion of a white pigment in which the refractive index is within the range enables the formation of a high quality image.

The specific surface area of the above white pigment by the BET method is preferably less than 100 m²/g. When the specific surface area of the above white pigment by the BET method is less than 100 m²/g, the penetration of a coating solution is restrained in the coating formation of an ink receiving layer, whereby the absorption of an ink solvent during printing can be enhanced.

The term “the BET method” means one of the surface area measurement methods of powder by gas phase adsorption; the process determines the total surface area for 1 g of a specimen from the adsorption isothermal line, i.e., a specific surface area. Normally nitrogen gas is used as an adsorption gas; in general the amount of adsorption is determined from the change of the pressure or volume of an adsorbed gas. A well known equation that indicates the isothermal line of multimolecular adsorption is the equation of Brunauer, Emmett and Teller, whereby the amount of adsorption is evaluated, with the amount multiplied by the area occupied by one adsorbed molecule on the surface, leading to being capable of the calculation of the surface area.

The content of the above white pigment in the aforementioned undercoat layer is preferably for example from 5 to 20% by mass based on the mass of the aforementioned thermoplastic resin particulates although the content varied depending on the kinds of white pigment and thermoplastic resin, the layer thickness, etc., more preferably from 10 to 20% by mass.

Additionally, to the above undercoat layer can also be added a well known additive such as an antioxidant.

An ink solvent permeable undercoat layer installed on a support of the invention is formed by use of a dispersion solution containing the above thermoplastic resin particulates and the above white pigment; the undercoat layer can be formed, for example, by application of (1) a dispersion solution prepared by additional dispersion of a white pigment in a thermoplastic resin particulates dispersed in a desired solvent; or (2) a dispersion solution prepared by mixture of a dispersion solution of dispersion of a thermoplastic resin particulates and a dispersion solution of dispersion of a white pigment; etc. to, for example, on the surface of a paper substrate by means of a well known process such as coating.

The formation of the above ink solvent permeable undercoat layer by coating involves, for example in accordance with (2) above, preparing in advance a latex dispersion solution of dispersion of thermoplastic resin particulates in water and a pigment dispersion solution of dispersion of a white pigment in water, and then uniforming them (as required, together with other components) by mixture and agitation to prepare a coating solution (hereinafter, may be called a “coating solution for an ink solvent permeable undercoat layer”) for ink solvent permeable undercoat layer formation. Also, the formation of the above undercoat layer in accordance with (1) above may involve the first dispersion in water of one of thermoplastic resin particulates and a white pigment, the addition of the other (as necessary, along with other components) thereto to prepare a coating solution for an ink solvent permeable undercoat layer by dispersion and uniforming, the application of the coating solution thus prepared to the surface of a paper substrate (as required, using another layer) by means of a well known coating process in such a way that a dried coated amount of the layer is from 2 to 20 g/m², and then the drying of the resulting material, resulting in appropriate formation.

The above-described undercoat layer may also be formed, in addition to the use of the coating process, by the immersion of a paper substrate in a coating solution for an ink solvent permeable undercoat layer, or by the spraying of a coating solution for an ink solvent permeable undercoat layer on a paper substrate.

An ink solvent permeable undercoat layer is formed so that a dried coated amount of the layer is from 2 to 20 g/m². The dried coated amount is more preferably from 4 to 20 g/m². When the dried coated amount is within the range of from 2 to 20 g/m², the penetration of a coating solution for ink receiving layer formation can be suppressed that is coated on an ink solvent permeable undercoat layer, and also a sufficient gloss imparting effect can be obtained. Additionally, rare generation of coating unevenness can lead to excellent coated face properties of the ink receiving layer, high ink solvent permeability, and a sufficient bleeding suppression effect.

Examples of coating of a coating solution for the above undercoat layer that may be more suitably carried out include well known coating processes such as the blade coating process, the bar coating process, and the spray coating process. The solid component concentration of the above coating solution for a support is desirably in the range of from 15 to 65% by mass.

The layer thickness of the aforementioned undercoat layer is preferably from 0.2 to 5.0 μm, more preferably from 0.5 to 3.0 μm. Where the layer thickness of the above undercoat layer is from 0.2 to 5.0 μm, the layer having a high glossness surface, and whiteness with a small amount of a white pigment can be obtained when calender treatment as will be described below is conducted, and at the same time oozing with time readily generated when a file is stored immediately after printing can effectively be prevented due to immediate permeation of an ink solvent.

Paper Substrate

A support in the invention can use one that is produced by application of the above ink solvent permeable undercoat layer to the surface of a paper substrate; the support is constructed by use of the paper substrate, so the utilization of absorption capability paper material originally possesses allows the ink solvent permeated through the ink solvent permeable undercoat layer to be absorbed in the paper substrate.

The paper substrate may be a natural pulp paper containing a common natural pulp as the main component; a mixed paper containing a natural pulp and a synthetic fiber; a synthetic fiber paper containing a synthetic fiber as the main component; or a so-called synthetic paper, which is produced from a synthetic resin film of polystyrene, polyethylene terephthalate, polypropylene, or the like. Natural pulp papers (hereinafter, referred to simply as the “base paper”) are particularly preferable as the paper base support. The base paper may be a neutral paper (pH: 5 to 9) or an acidic paper, but is preferably a neutral paper.

The above base paper can use one which has as the primary raw material natural pulp selected from conifers, broadleaf trees, etc and to which are added as nesessary a loading material such as clay, talc, calcium carbonate, or urea resin particulates; a sizing agent such as rosin, an alkylketene dimer, a higher fatty acid, an epoxidized fatty acid amide, paraffin wax, or alkenylsuccinic acid; a paper strength intensifying agent such as starch, polyamidepolyamine-epichlorohydrin, or polyacrylamide, and a bonding agent such as aluminum sulfate or a cationic polymer. Also, a softening agent such as a surfactant may be added thereto. Synthetic paper may be used that uses synthetic pulp instead of the above natural pulp, or a mixture of natural pulp and synthetic pulp in an arbitrary ratio may be used. Of these, a leafbroad tree of short fiber and high evenness is preferably used. The hydrature of pulp material to be used is preferably in the range of from 200 to 500 ml (C.S.F.), more preferably in the range of from 300 to 400 ml.

The paper substrate may contain additionally other component such as a sizing agent, softening agent, paper strength additive, and fixing agent. The sizing agents include rosins, paraffin waxes, higher aliphatic acid salts, alkenyl succinate salts, aliphatic acid anhydrides, styrene-maleic anhydride copolymers, alkylketene dimers and epoxidized aliphatic acid amides. The softening agents include reaction products from maleic anhydride copolymers and polyalkylene polyamines and higher aliphatic acid quaternary ammonium salts. The paper strength additives include polyacrylamide, starch, polyvinyl alcohol, melamine-formaldehyde condensates, gelatin, and the like. The fixing agents include aluminum sulfate, polyamide polyamine epichlorohydrins, and the like. Additionally, a dye, fluorescence dye, anti-static agent or the like may be added if necessary.

The aforementioned paper substrate is preferably first subjected to activation treatment such as corona discharge treatment, flame treatment, glow discharge treatment, or plasma treatment prior to the formation of an ink solvent permeable undercoat layer as described above.

A support of the invention may use resin coating paper having a resin layer at least on the side where the above ink receiving layer is disposed. The resin coating paper is preferably one that has a resin layer containing an electronic beam hardened material of a polyolefin or an unsaturated organic compound on the above paper substrate.

Calender Treatment

A support of the invention is preferably one that is made to undergo calender treatment after the formation of the above undercoat layer on the above paper substrate by means of a calender (soft calender or super calender or both) in which at least one of a pair of rolls is made of a metal roll under the conditions which cause the surface temperature of the above metal roll to be equal to or higher than the glass transition temperature of the above thermoplastic resin particulates and also cause the nip pressure of the above pair of the rolls to be 50 to 400 kg/cm.

As described above, after a paper substrate is coated with an ink solvent permeable undercoat layer, the conduct of calender treatment under specific conditions ensures high gloss properties, high evenness, and high quality image formation properties of the surface of an ink receiving layer formed using the aforementioned undercoat layer and simultaneously enhances the absorption of the ink solvent in the ink imparted to the ink receiving layer during printing, thereby being capable of effectively restraining bleeding (bleeding with time) of the formed image along with time elapse.

The above soft calender treatment is preferably carried out by means of a soft calender comprising a pair of rolls, at least one of which is comprised of a metal roll (preferably, comprised of a metal roll and a resin roll), or a super calender or both, under the conditions that cause the surface temperature of the metal roll to be equal to or higher than the glass transition temperature of the thermoplastic resin particulates as mentioned above and also cause the nip pressure between the roll nips in the pair of the rolls to be 50 to 400 kg/cm.

Hereinafter, a soft calendar and a super calendar, both having a metal roll and a resin roll, will be set forth in detail. As long as the metal roll is a cylindrical or columnar roll of an even surface; the inside of the roll has a means of heat application; the roll is not restrained by material thereof, etc., and a well known metal roll can be as appropriate selected for use. Also, the above metal roll is preferably as smooth as possible since the metal roll touches the recording face side of the faces of both sides of the support in calendar treatment, that is, the face of the side of the ink receiving layer as will be described below. The above surface roughness is specifically preferably 0.3 s or less in terms of the surface roughness stipulated in JIS B0601, more preferably 0.2 s or less.

The surface temperature in the treatment of the above metal roll is generally preferably from 70 to 250° C. for base paper treatment. On the other hand, when the paper substrate on which the ink solvent permeable undercoat layer is coated is treated, the surface temperature is preferably equal to or more than the glass transition temperature Tg of the thermoplastic resin particulates contained in the ink solvent permeable undercoat layer, more preferably the above Tg or more +40° C. or less.

The above resin roll may be selected as appropriate from a synthetic resin roll comprising a polyurethane resin, a polyamide resin and the like; the shore D hardness is suitably from 60 to 90.

The nip pressure of the pair of rolls having the above metal roll is appropriately from 50 to 400 kg/cm, preferably from 100 to 300 kg/cm. The treatment is desirably carried out about once or twice when a soft calender and/or super calender is used that is provided with a pair of rolls that are disposed as described above.

Thus, the use of a paper base material for a substrate makes it possible for the substrate to absorb the imparted ink solvent of an ink; the use of a paper base material maintains easy-to-be-decreased gloss properties, evenness and high quality image formation properties by the coating of the paper base material surface with an ink solvent permeable undercoat layer, and simultaneously the impartation of solvent permeable capability to the layer enables oozing with time caused by the ink solvent that does not evaporate and remains immediately after printing to be effectively avoided as well.

A support used for an ink jet recording medium of the invention is not particularly limited; a read only optical disk such as CD-ROM, or DVD-ROM, a write once optical disk or a rewritable optical disk is used as the support, whereby an ink receiving layer and a gloss imparting layer can also be imparted to the level face side.

(Ink Receiving Layer)

The above ink receiving layer preferably contains at least a water-soluble resin, a crosslinking agent capable of crosslinking the water-soluble resin and particulates, and may additionally contain as necessary other components such as a dye mordant and a surfactant.

Ink-absorbing capacity of the ink receiving layer is improved by porous structure formed by containing the fine particles in the ink receiving layer. In particular, when the content of the fine particles in the solid matters of the ink receiving layer is 50% or more, more preferably 60% by mass, the ink receiving layer has a more favorable porous structure, further increasing the ink absorptive property thereof. Here, the content of the fine particles in the solid matters of the ink receiving layer is a content calculated with respect to the components other than water in the composition for the ink receiving layer.

The ink receiving layer of the above porous structure refers to a layer having a porosity of from 50 to 75%, preferably from 60 to 70%. When the above porosity is within the range of from 50 to 75%, the problem of powder falling due to the lack of a binder is not caused. In terms of the quality of an ink jet recording medium, the layer thickness of an ink receiving layer is preferably from 20 to 40 μm, and the grossness of 60° preferably from 30 to 70%.

Particulates

The above particulates can utilize both organic particulates and inorganic particulates. Preferable examples of the above organic particulates include polymer particulates obtained by emulsion polymerization, microemulsion-based polymerization, soap free polymerization, seed polymerization, dispersion polymerization, suspension polymerization, etc., more specifically powders of polyethylene, polypropylene, polystyrene, polyacrylates, polyamides, silicone resins, phenol resins, natural polymers, etc., particulates of latex or emulsion-like polymers, and the like.

Alternatively, examples of the inorganic fine particles include fine particles of silicfine particles, colloidal silica, titanium dioxide, barium sulfate, calcium silicate, zeolite, kaolinite, halloysite, mica, talc, calcium carbonate, magnesium carbonate, calcium sulfate, pseudoboehmite, zinc oxide, zinc hydroxide, aluminfine particles, aluminium silicate, calcium silicate, magnesium silicate, zirconium oxide, hydroxide zirconium, cerium oxide, lanthanum oxide, yttrium oxide, and the like.

Among them, inorganic fine particles are preferable, from the viewpoints of ink absorptive property and image stability. Silicfine particles, colloidal silica, aluminfine particles, or pseudoboehmite is preferable for preparing a more favorable porous structure.

Silicfine particles are commonly classified roughly into wet method particles and dry method (gas phase process) particles according to the method of manufacture. By the wet method, silicfine particles are mainly produced by generating an activated silica by acid decomposition of a silicate, polymerizing properly the activated silica, and coagulating the resulting polymeric silica to give a hydrated silica. Alternatively by the gas phase process, vapor-phase process silica (anhydrous silica) particles are mainly produced by high-temperature gas-phase hydrolysis of a silicon halide (flame hydrolysis process), or by reductively heating and vaporizing quartz and coke in an electric furnace by applying an arc discharge and then oxidizing the vaporized silica with air (arc method). The “vapor-phase process silica” means an anhydrous silicfine particles produced by the gas phase process. Vapor-phase process silicfine particles are especially preferable as the silicfine particles according to the invention.

Silica by the gas phase process is different from water-containing silica in packed density of the silanol groups and the presence or absence of holes, so they exhibit different properties; and is suitable for the formation of three dimensional structure of a high porosity. It is estimated as follows. Although the reason is not verified, for water-containing silica the density of the silanol groups is large at from 5 to 8/nm² on the particulate surface, and thus silica particulates are readily aggregate densely. On the other hand, with silica by the gas phase process the density of the silanol groups on the particulate surface is small at from 2 to 3/ nm², so the silica sparsely flocculates, a structure having a high porosity results.

The vapor-phase process silica has an extremely high specific surface area, and provides the layer higher in ink absorption and retention capacity. In addition, the vapor-phase process silica has a lower refractive index, and thus if dispersed to a suitable particles diameter, provides the ink receiving layer with better transparency, and higher color density and favorable coloring of printed images. The transparency of ink receiving layer is important from the viewpoint of obtaining a high color density and favorable coloring glossiness not only for applications wherein the transparency is required such as OHP sheets and the like, but also for applications as recording sheets such as photographic glossy papers and the like.

The average primary particles diameter of the vapor-phase process silica is preferably 50 nm or less, more preferably 20 nm or less, particularly preferably 10 nm or less, and most preferably 3 to 10 nm. Vapor-phase process silica particles tend to bind to each other via hydrogen bonds between silanol groups, and thus silica particles having an average primary particles diameter of 50 nm or less provides a structure having high void percentage, thus effectively improving the ink-absorbing property.

Additionally, both the silica particulates prepared by the gas phase process and other particulates as described above may be used together. When both the other particulates and the silica by the gas phase process are used together, the content of the silica by the gas phase process in the total particulates is preferably 30% by mass or more, more preferably 50% by mass or more.

Preferable examples of the above inorganic particulates also include alumina particulates, alumina hydrates, a mixture thereof or a complex thereof. Of these, because of good absorption and fixation of ink, etc., alumina hydrates are preferable, in particular pseudoboehmite (Al₂O₃.nH₂O) is preferable. Although a variety of forms can be used for the above alumina hydrates, sol-like boehmite is preferably used as a starting material.

For the pore structure of the above pseudoboehmite, the average pore radius is preferably from 1 to 25 nm, more preferably from 2 to 10 nm. The pore volume is preferably from 0.3 to 2.0 ml/g [cc/g], more preferably from 0.5 to 1.5 ml/g [cc/g]. The pore radius and the pore volume are determined by the nitrogen adsorption desorption process, for example a gas adsorption desorption analyzer (e.g., “Omnisorp 369” (trade name) manufactured by Beckman Coulter, Inc.) may be used for determination.

Among aluminfine particles, gas phase process aluminfine particles having a greater specific surface area are preferable. The average primary particles diameter of the gas phase process aluminfine particles is preferably 50 nm or less and more preferably 20 nm or less. Colloidal silicas having an average primary particles diameter of 50 nm or less are also included in preferable examples.

Examples of the above particulates that may be preferably used also include the forms disclosed in JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314.

Water-Soluble Resin

Examples of the water-soluble resins used for the ink receiving layer include polyvinyl alcohol resins having a hydroxy group as the hydrophilic constitutional unit [polyvinyl alcohol (PVA), acetoacetyl-modified polyvinyl alcohol, cation-modified polyvinyl alcohol, anion-modified polyvinyl alcohol, silanol-modified polyvinyl alcohol, polyvinylacetal, etc.]; cellulosic resins [methylcellulose (MC), ethylcellulose (EC), hydroxyethylcellulose (HEC), carboxymethylcellulose (CMC), hydroxypropylcellulose (HPC), hydroxyethylmethylcellulose, hydroxypropylmethylcellulose, etc.]; chitins; chitosans; starch; ether bond-containing resins [polyethylene oxide (PEO), polypropylene oxide (PPO), polyethylene glycol (PEG), polyvinyl ether (PVE), etc.]; carbamoyl group-containing resins [polyacrylamide (PAAM), polyvinylpyrrolidone (PVP), polyacrylic acid hydrazide, etc.]; and the like. In addition, resins having a carboxyl group as the dissociative group, such as polyacrylate salts, maleic acid resins, and alginate salts; gelatins, and the like, are also included. The water-soluble resins may be used alone or in combination of two or more.

Among them, polyvinyl alcohol resins are particularly preferable. Examples of the polyvinyl alcohols include those described in Japanese Patent Application Publication (JP-B) Nos. 4-52786, 5-67432, and 7-29479; Japanese Patent No. 2537827; JP-B No. 7-57553; Japanese Patent Nos. 2502998 and 3053231; JP-A No. 63-176173; Japanese Patent No. 2604367; JP-A Nos. 7-276787, 9-207425, 11-58941, 2000-135858, 2001-205924, 2001-287444, 62-278080, and 9-39373; Japanese Patent No. 2750433; JP-A Nos. 2000-158801, 2001-213045, 2001-328345, 8-324105, and 11-348417; and the like. In addition, examples of the water-soluble resins except the polyvinyl alcohol resins include those described in paragraphs [0011] to [0014] of JP-A No. 11-165461.

The content of the water-soluble resin in the ink receiving layer is preferably 9 to 40%, more preferably 12 to 33% by mass with respect to the total weight of the solid matter in ink receiving layer. These water-soluble resins and the fine particles described above each may be a single-component substance or a multiple-component substance.

From the viewpoint of ensuring transparency of the ink receiving layer, selection of the kind of the water-soluble resin used in combination with the fine particles, especially with silicfine particles, is important. For combination with the vapor-phase process silica, polyvinyl alcohol resins are preferable as the water-soluble resin. Among them, polyvinyl alcohol resins having a saponification value 70 to 100% are preferable, and polyvinyl alcohol resins having a saponification value of 80 to 99.5% are particularly preferable.

The polyvinyl alcohol resins contain a hydroxyl group as the structural unit. Hydrogen bonding between the hydroxyl groups and the surface silanol groups on silicfine particles allows silicfine particles to form a three-dimensional network structure having secondary particles as the network chain units. This three-dimensional network structure thus constructed seems to be the cause of easier development of an ink receiving layer having a porous structure higher in void percentage and strength. In ink jet recording, the ink receiving layer having a porous structure obtained in this manner absorbs inks rapidly due to the capillary phenomenon, and provides printed dots superior in circularity without ink bleeding.

In addition, the polyvinyl alcohol resin may be used together with other water-soluble resins. When another water-soluble resin and the polyvinyl alcohol resin are used in combination, the amount of polyvinyl alcohol resin is preferably 50% or more, more preferably 70% by mass or more with respect to total water-soluble resins.

Ratio of the Fine Particles to the Water-Soluble Resin Contained

The ratio of the weight of fine particles x to the weight of water-soluble resin y (PB ratio: x/y) has a great influence on the structure and strength of the ink receiving layer. A larger weight ratio (PB ratio) tends to result in increase in void percentage, pore volume, and surface area (per unit weight) but decrease in density and strength.

The PB ratio (x/y) for the ink receiving layer is preferably 1.5 to 10, from the viewpoints of suppressing the decrease in layer strength and preventing cracking thereof when dried which may be caused due to an excessively larger PB value, and of preventing decrease in void percentage and thus in ink absorptive property due to an larger amount of voids eliminated more easily due to an excessively lower PB ratio.

When an ink jet recording medium is passed through the transport system of the ink jet recording medium, the ink receiving layer needs to have a sufficient layer strength since the ink jet recording medium undergoes stress in some cases, and also from the standpoint of the prevention of cracking, releasing, etc. of the ink receiving layer even in the cutting processing into a sheet shape. Considering these, the aforementioned PB ratio is more preferably 5 or less; on the other hand, the ratio is more preferably 2 or more from the standpoint of security of high-speed ink adsorption in an ink jet printer.

For instance, when a coating solution prepared by the complete dispersion of silica particulates having an average primary particle diameter of 20 nm or less by the gas phase process and a water-soluble resin in an aqueous solution in a PB ratio (x/y) of from 2 to 5 is applied to the surface of a support and the resulting supporter is dried, a three dimensional net structure is formed in which secondary particles of the silica particulates are net chains; a transparent porous layer of the net structure can readily be formed that has an average pore diameter of 25 nm or less, a porosity of from 50 to 80%, a pore specific volume of 0.5 ml/g or more, and a specific area of 100 m²/g or more.

Crosslinking Agent

An ink receiving layer in the invention has a layer that contains inorganic particulates, water-soluble resin, etc. that additionally contains a crosslinking agent capable of crosslinking the water-soluble resin; the ink receiving layer is preferably a form that is a porous layer cured by the crosslinking reaction of the crosslinking agent with the water-soluble resin.

The above crosslinking agent may be used as appropriate by selection of a suitable agent in association with a water-soluble resin contained in an ink receiving layer. Of these, boric acid or a boron compound is preferable in rapid crosslinking reaction. Examples of the above boron compounds include borax, borate salts (e.g., orthoborate salts, InBO₃, ScBO₃, YBO₃, LaBO₃, Mg₃(BO₃)₂, Co₃(BO₃)2), diborate salts (e.g., Mg₂B₂O₅, Co₂B₂O₅), metaborate salts (e.g., LiBO₂ , Ca(BO₂)₂, NaBO₂, KBO₂), tetraborate salts (e.g., Na₂B₄O₇.10H₂O), pentaborate salts (e.g., KB₅O₈.4H₂O, CsB₅O₅), Ca₂B₆O₁₁.7H₂O, and the like.

Of these, borax, boric acid and borate salts are preferable in that crosslinking reaction is rapid, boric acid is more preferable, and the combination use of these and polyvinyl alcohols, i.e., water-soluble resins, is most preferable.

The content of the cross-linking agent is preferably 0.05 to 0.50 part, more preferably 0.08 to 0.30 part by mass, with respect to 1 part by mass of the water-soluble resin. If the content of the cross-linking agent is in the above range, the water-soluble resin is crosslinked more efficiently, preventing cracking of the resulting layers.

For instance, with the use of gelatin as the above water-soluble resin, compounds below may be used as crosslinking agents in addition to boron and boron compounds. The examples include aldehyde-based compounds such as formaldehyde, glyoxal and glutaraldehyde; ketone-based compounds such as diacetyl and cyclopentanedione; active halogen compounds such as bis(2-chloroethyl urea)-2-hydroxy-4,6-dichloro-1,3,5-triazine, 2,4-dichloro-6-S-triazine·sodium salt; active vinyl compounds such as divinylsulfonic acid, 1,3-vinylsulfonyl-2-propanol, N,N′-ethylenebis(vinylsulfonylacetamide), and 1,3,5-triacryloyl-hexahydro-S-triazine; N-methylol compounds such as dimethylol urea and methyloldimethylhydantoin; melamine resins (e.g., methyllolmelamine, alkylated methylolmelamines); epoxy resins; isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; epoxy compounds such as glycerol triglycidylether; ethylene imino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chrome alum, potassium alum, zirconyl acetate, and chromium acetate; polyamine compounds such as tetraethylene pentamine; hydrazide compounds such as adipic acid dihydrazide; low-molecular weight compounds or polymers having 2 or more oxazoline groups; and the like. The cross-linking agents may be used alone or in combination of two or more.

A crosslinking agent may be applied to a coating solution for forming an ink receiving layer (hereinafter, may be called a “coating solution for an ink receiving layer”) when the coating solution for the ink receiving layer and/or to a coating solution for forming the adjacent layer, or a crosslinking agent may be supplied to an ink receiving agent, for example, by the application of the above coating solution for the ink receiving layer to a supporter coated with a coating solution containing in advance the crosslinking agent, or by the overcoating of a coating solution for an ink receiving layer not containing the crosslinking agent after coated and dried with the crosslinking agent.

For instance, a crosslinking agent may be imparted as follows. Here, an example of a boron compound will be set forth. That is, where an ink receiving layer is a layer that crosslinks and cures a coated layer coated with a coating solution for an ink receiving layer (a first solution), crosslinking curing may be carried out by impartation of a basic solution of pH 7.1 or more (a second solution) to the above coated layer, (1) concurrently with the formation of the coated layer by application of the above coating solution, or (2) prior to the indication of the decreasing rate of drying of the coated layer during the drying of the coated layer formed by application of the above coating solution. A born compound, i.e., a crosslinking agent, may be contained in either the first solution or the second solution, or in both the first and second solutions, in advance. A specific method will be described below.

Mordant

In the invention, a mordant is preferably added to the ink receiving layer, for further improvement in the water resistance and resistance to bleeding over time of formed images. Both organic mordants such as cationic polymers (cationic mordants) and inorganic mordants such as water-soluble metal compounds may be used as the mordant. Among them, organic mordants are preferable, and cationic mordants are more preferable.

The presence of the above dye mordant at least on the upper layer of an ink receiving layer produces the interaction between liquid inks containing an anionic dye as a coloring material to stabilize the coloring material, thereby being capable of further improving durability and bleeding with time.

In such a case, the mordant may be contained either in the coating solution for ink receiving layer (first solution) or the basic solution (second solution) for forming the ink receiving layer, but is preferably contained in the second solution, which is different from the solution containing an inorganic fine particles (especially, vapor-phase process silica). It is because addition of the mordant directly into the coating solution for the ink receiving layer may result in coagulation in the presence of a vapor-phase process silica having anion electric charges. However, adoption of the method of separately preparing and applying the mordant-containing solution and the coating solution for ink receiving layer eliminates the concern about coagulation of inorganic fine particles, and broaden the range of choice for the mordant.

Polymeric mordants having a primary to tertiary amino group or a quaternary ammonium salt group as the cationic functional group are favorably used as the cationic mordant. Nonpolymeric cationic mordants may also be used.

Homopolymers from monomers having a primary to tertiary amino group or a salt thereof or a quaternary ammonium salt group (hereinafter, referred to as the “mordant monomer”) and copolymers or condensation polymers of the mordant monomers with other monomers (hereinafter, referred to as the “nonmordant polymer”) are more preferably as the polymeric mordant. These polymeric mordant may be used in the form of a water-soluble polymer or a latex particles dispersed in water.

Examples of the above dye mordant monomers include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride; trimethyl-p-vinylbenzylammonium bromide, trimethyl-m-vinylbenzylammonium bromide, trimethyl-p-vinylbenzylammonium sulphonate, trimethyl-m-vinylbenzylammonium sulphonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, and N,N -diethyl-N-methyl-N-2-(4-vinylphenyl)ethylammonium acetate; quarternary ammonium compounds prepared by reactions of methyl chloride, ethyl chloride, methyl bromide, ethyl bromide, methyl iodide or ethyl iodide with N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylaminoethyl (meth)acrylamide, N,N-dimethylaminopropyl (meth)acrylamide, or, N,N-diethylaminopropyl(meth)acrylamide; or the anion-exchanged sulfonate salts, alkylsulfonate salts, acetates or alkyl carboxylates thereof; and the like.

Specific examples of the compounds include monomethyldiallylammonium chloride, trimethyl-2-(methacryloyloxy)ethylammonium chloride, trimethyl-2-(acryloyloxy)ethylammonium chloride, triethyl-2-(mathacryloyloxy)ethylammonium chloride, triethyl-3-(methacryloyloxy)propylammonium chloride, triethyl-2-(methacryloyloxy)ethylammonium chloride, triethyl-2-(acryloyloxy)ethylammonium chloride, trimethyl-2-(methacryloyloxy)propylammonium chloride, trimethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, and triethyl-3-(acryloylamino)propylammonium chloride; N,N-dimethyl-N-ethyl-2-(methacrlyloyloxy)ethylammonium chloride, N,N-diethyl-N-methyl-2-(methacrlyloyloxy)ethylammonium chloride, N,N-dimethyl-N-ethyl-3-(acryloylamino)propylammonium chloride, trimethyl-2-(methacrlyloyloxy)ethylammonium bromide, trimethyl-3-(acryloylamino)propylammonium bromide, trimethyl-2-(methacrlyloyloxy)ethylammonium sulfonate, trimethyl-3-(acryloylamino)propylammonium acetate; and the like.

In addition, copolymerizable monomers such as N-vinylimidazole and N-vinyl-2-methylimidazole are also included.

Also, allylamine, diallylamine, derivatives thereof, and salts thereof may be utilized as well. Examples of the compounds include allylamine, allylamine hydrochloric acid salts, allylamine acetic acid salts, allylamine sulfuric acid salts, diallylamine, diallylamine hydrochloric acid salts, diallylamine acetic acid salts, diallylamine sulfuric acid salts, diallylmethylamine and salts thereof (the salts including, for example, hydrochloric acid salts, acetic acid salts, sulfuric acid salts), diallylethylamine and salts thereof (the salts including, for example, hydrochloric acid salts, acetic acid salts, sulfuric acid salts), diallyldimethylammonium salts (paired anions of the salts including chloride, acetate ion, sulfate ion), and the like. Additionally, because allylamine and diallylamine derivatives thereof are inferior in polymerization in the form of amines, general methods include polymerizing the compounds in salt forms, and then removing as required the salts.

Also, polymer units of N-vinylacetoamide, N-vinylformamide, etc. are used, and then vinylamine units are made after hydrolysis, and also salts thereof may be utilized.

The above non-dye mordant monomers refer to monomers which do not include basic or cationic portions of the primary to the tertiary amino groups and salts thereof, or the quarternary ammonium bases, etc. and which do not show the interaction with a dye in an ink for an ink jet, or which are monomers of substantially small interaction.

Examples of the above non-dye mordant monomers include alkyl (meth)acrylates; cycloalkyl (meth)acrylates such as cyclohexyl (meth)acrylate; aryl (meth)acrylates such as phenyl (meth)acrylate; aralkyl esters such as benzyl (meth)acrylate; aromatic vinyls such as styrene, vinyltoluene, and α-methylstyrene; vinyl esters such as vinyl acetate, vinyl propionate, and vinyl versatate; allyl esters such as allyl acetate; halogen-containing monomers such as vinylidene chloride and vinyl chloride; vinyl cyanides such as (meth)acrylonitrile; olefins such as ethylene and propylene; and the like.

The above alkyl (meth)acrylic acid ester is preferably an alkyl (meth)acrylic acid ester having the alkyl portion having from one to 18 carbon atoms; the specific examples include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate, and stearyl (meth)acrylate. Of these, methyl acrylate, ethyl acrylate, methyl methacrylate, ethyl methacrylate, and hydroxyethyl methacrylate are preferable. The above non-dye mordant monomers may also be used singly or in combination of two or more species.

Other favorable examples of the cationic mordants include polydiallydimethylamrnmonium chloride, polymethacrlyloyloxyethyl-β-hydroxyethyldimethylammonium chloride, polyethyleneimine, polyallylamine and the derivatives thereof, polyamide-polyamine resins, cationized starch, dicyandiamide formalin condensates, dimethyl-2-hydroxypropylammonium salt polymers, polyamidine, polyvinylamine, dicyandiamide-formalin polycondensates represented by dicyan-based cationic resins, dicyanamide-diethylenetriamine polycondensates represented by polyamine-based cationic resins, epichlorohydrin-dimethylamine addition polymers, dimethyldiallylammonium chloride-SO2 copolymers, diallyamine salt-SO2 copolymers, (meth)acrylate-containing polymers having a quaternary ammonium salt group-substituted alkyl group in the ester portion, styryl polymers having a quaternary ammonium salt group-substituted alkyl group, and the like.

Specific examples of the cationic mordants include those described in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134, and 1-161236; U.S. Pat. Nos. 2,484,430, 2,548,564, 3,148,061, 3,309,690, 4,115,124, 4,124,386, 4,193,800, 4,273,853, 4,282,305, and 4,450,224; JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314; JP-B Nos. 5-35162, 5-35163, 5-35164, and 5-88846; JP-A Nos. 7-118333 and 2000-344990; Japanese Patent Nos. 2648847 and 2661677; and the like. Among them, polyallylamine and the derivatives thereof are preferably and diallydialkylcation polymers are structurally preferable.

Various allylamine polymers and the derivatives thereof known in the art may be used as the polyallylamine or the derivatives thereof. Examples of these derivatives include salts of polyallylamine and an acid (the acids include inorganic acids such as hydrochloric acid, sulfuric acid, phosphoric acid, and nitric acid; organic acids such as methanesulfonic acid, toluenesulfonic acid, acetic acid, propionic acid, cinnamic acid, and (meth)acrylic acid, and the combinations thereof; and allylamine partially converted to the salt is also included), derivatives of polyallylamine prepared by polymer reactions, and copolymers of polyallylamine and a other copolymerizable monomer [the monomers include typically(meth)acrylic esters, styrenes, (meth)acrylamides, acrylonitrile, vinylesters, and the like].

Specific examples of the polyallylamine and the derivatives thereof include those described in JP-B Nos. 62-31722, 2-14364, 63-43402, 63-43403, 63-45721, 63-29881, 1-26362, 2-56365, 2-57084, 4-41686, 6-2780, 6-45649, 6-15592, and 4-68622; Japanese Patent Nos. 3199227 and 3008369; JP-A Nos. 10-330427, 11-21321, 2000-281728, 2001-106736, 62-256801, 7-173286, 7-213897, 9-235318, 9-302026, and 11-21321; WO 99/21901 and 99/19372; JP-A No. 5-140213; Japanese Patent Application National Publication (Laid-Open) No. 11-506488; and the like.

Among the cationic mordants, diallydialkylcation polymers are preferable, and diallydimethylcation polymers are particularly preferable. The cationic mordant is preferably a cationic polymer having a weight-average molecular weight of 60,000 or less, more preferably of 40,000 or less, from the viewpoints of dispersibility, especially of preventing increase in viscosity.

The cationic mordant is also useful as the dispersant for the fine particles.

When added into the coating solution for ink receiving layer, the sulfate ion concentration in the coating solution is preferably 1.5% by mass or less, from the viewpoint of preventing increase in viscosity. The sulfate ion derives from the polymerization initiator or the like used during production of the cationic polymer. Accordingly, it is advantageous to use a cationic mordant prepared by using a polymerization initiator or the like that does not release sulfate ions, as the sulfate ions remain in the polymer.

The above inorganic dye mordants include multivalent water-soluble metal salts and hydrophobic metal salt compounds. Specific examples of the above inorganic dye mordants include salts or complexes of the metals selected from magnesium, aluminum, calcium, scandium, titanium, vanadium, manganese, iron, nickel, copper, zinc, gallium, germanium, strontium, yttrium, zirconium, molybdenum, indium, lanthanum, cerium, praseodymium, neodymium, samarium, europium, gadolinium, dysprosium, erbium, ytterbium, hafnium, tungsten, and bismuth.

More specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, cupric ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminium sulfate, aluminium alum, basic polyhydroxy aluminum, aluminum sulfite, aluminum thiosulfate, polychlorinated aluminum, aluminium nitrate nonahydrate, aluminium chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, zirconium ammonium carbonate, zirconyl stearate, zirconyl octoate, zirconyl nitrate, zirconium oxychloride, zirconium hydroxychloride, chromium acetate, chromium sulfate, manganese sulfate, magnesium chloride hexahydrate, magnesium citrate nonahydrate, sodium phosphotungstate, sodium tungsten citrate, undecatungstophosphoric acid n-hydrate, undecatungstosilicic acid 26-hydrate, molybdenum chloride, undecamolybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octoate, praseodymium nitrate, neodymium nitrate, samarium nitrate, europium nitrate, gadolinium nitrate, dysprosium nitrate, erbium nitrate, ytterbium nitrate, hafnium chloride, bismuth nitrate, and the like.

Of the above-described inorganic dye mordants, aluminum-bearing compounds, titanium-bearing compounds, zirconium-bearing compounds, and metal compounds (salts or complexes) of the IRB series of the periodic table are preferable.

The amount of addition of the above dye mordant in the above ink receiving layer is preferably from 0.01 to 5 g/m², more preferably from 0.1 to 3 g/m².

Other Components

The ink receiving layer according to the invention may additionally contain, if necessary, various additives known in the art such as acid, ultraviolet-absorbent, antioxidant, fluorescent whitening agent, monomer, polymerization initiator, polymerization inhibitor, anti-bleeding agent, antiseptic, viscosity stabilization agent, antifoamer, surfactant, antistatic agent, matting agent, anti-curl agent, water-resistance imparting agent, and the like.

An ink receiving layer in the invention may contain an acid. The adjustment of the surface pH of the ink receiving layer to from 3 to 8, preferably from 3.5 to 6.0, by the addition of the aforementioned acid enables the improvement of yellow change resistance of the white portion. The determination of the surface pH may be conducted by use of method A (the coating process) of the surface pH determinations set by J. TAPPI, for example, the pH determining set for paper “Type MPC” corresponding to method A above, manufactured by Kyoritsu Chemical-Check Lab., Corp., may be used.

Specific examples of the acids include formic acid, acetic acid, glycolic acid, oxalic acid, propionic acid, malonic acid, succinic acid, adipic acid, maleic acid, malic acid, tartric acid, citric acid, benzoic acid, phthalic acid, isophthalic acid, glutaric acid, gluconic acid, lactic acid, aspartic acid, glutamic acid, salicylic acid, salicylic acid metal salts (salt of Zn, Al, Ca, Mg, or the like), methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfonic acid, benzenesulfonic acid, sufanilic acid, sulfamic acid, α-resorcinic acid, β-resorcinic acid, γ-resorcinic acid, gallic acid, fluoroglycine, sulfosalicyclic acid, ascorbic acid, erythorbic acid, bisphenolic acid, hydrochloric acid, nitric acid, sulfuric acid, phosphoric acid, polyphosphoric acid, boric acid, boronic acid, and the like. The amount of the acid added is suitably determined so that the surface pH of the ink receiving layer becomes 3 to 8.

The acid may be used as a metal salt (e.g., a salt of sodium, potassium, calcium, cesium, zinc, copper, iron, aluminium, zirconium, lanthanum, yttrium, magnesium, strontium, cerium, or the like), or as an amine salt (e.g., a salt of ammonia, triethylamine, tributylamine, piperazine, 2-methylpiperazine, polyallylamine, or the like).

The ink receiving layer according to the invention preferably contains an additive for improving storage stability such as an ultraviolet absorbent, antioxidant, anti-bleeding agent, or the like.

The ultraviolet absorbents, antioxidants, and anti-bleeding agents that may be added include alkylated phenolic compounds (including hindered phenolic compounds), alkylthiomethylphenol compounds, hydroquinone compounds, alkylated hydroquinone compounds, tocopherol compounds, thiodiphenylether compounds, compounds having two or more thioether bonds, bisphenol compounds, O-, N- and S-benzyl compounds, hydroxybenzyl compounds, triazine compounds, phosphonate compounds, acylaminophenol compounds, ester compounds, amide compounds, ascorbic acid, amine-based antioxidants, 2-(2-hydroxyphenyl)benzotriazole compounds, 2-hydroxy benzophenone compounds, acrylates, water-soluble or hydrophobic metal salts, organic metal compounds, metal complexes, hindered amine compounds (including TEMPO compounds), 2-(2-hydroxyphenyl) 1,3,5-triazine compounds, metal deactivators, phosphite compounds, phosphonite compounds, hydroxylamine compounds, nitrone compounds, peroxide scavengers, polyamide stabilizers, polyether compounds, basic auxiliary stabilizers, nucleating agents, benzofuranone compounds, indolinone compounds, phosphine compounds, polyamine compounds, thiourea compounds, urea compounds, hydrazide compounds, amidine compounds, saccharide compounds, hydroxybenzoic acid compounds, dihydroxybenzoic acid compounds, trihydroxybenzoic acid compounds, and the like.

Among them, at least one compound selected from the group consisting of alkylated phenolic compounds, compounds having two or more thioether bonds, bisphenol compounds, ascorbic acid, amine-based antioxidants, water-soluble or hydrophobic metal salts, organic metal compounds, metal complexes, hindered amine compounds, polyamine compounds, thiourea compounds, hydrazide compounds, hydroxybenzoic acid compounds, dihydroxybenzoic acid compounds, and trihydroxybenzoic acid compounds is preferably contained therein.

Specific examples of the compounds include the compounds described in Japanese Patent Application No. 2002-13005, JP-A Nos. 10-182621 and 2001-260519, JP-B Nos. 4-34953 and 4-34513, JP-A No. 11-170686, JP-B No. 4-34512, EP No. 1138509, JP-A Nos. 60-67190, 7-276808, 2001-94829, 47-10537, 58-111942, 58-212844,59-19945, 59-46646, 59-109055, 63-53544, JP-B Nos. 36-10466, 42-26187, 48-30492, 48-31255, 48-41572, 48-54965, 50-10726, U.S. Pat. Nos. 2,719,086, 3,707,375, 3,754,919, 4,220,711, JP-B Nos. 45-4699, 54-5324, European Patent Application Laid-Open Nos. 223739, 309401, 309402, 310551, 310552 and 459416, OLS No. 3435443, JP-A Nos. 54-48535, 60-107384, 60-107383, 60-125470, 60-125471, 60-125472, 60-287485, 60-287486, 60-287487,60-287488, 61-160287, 61-185483, 61-211079,62-146678, 62-146680, 62-146679, 62-282885, 62-262047, 63-051174, 63-89877, 63-88380, 63-88381, 63-113536, 63-163351, 63-203372, 63-224989, 63-251282,63-267594, 63-182484, 1-239282, 2-262654, 2-71262, 3-121449, 4-291685, 4-291684, 5-61166, 5-119449, 5-188687, 5-188686, 5-110490, 5-1108437, and 5-170361; JP-B Nos. 48-43295 and 48-33212; U.S. Pat. Nos. 4,814,262 and 4,980,275; and the like.

Other additives may be added singly or in combination of two or more species. Another additive may be made to be a water solution, a dispersion material, a polymer dispersed material, an emulsion, or oil droplets and then be added, and may also be enclosed in microcapsules. The amount of addition of another additive that is to be added is preferably from 0.01 to 10 g/m².

The surface of fine particles may be treated with a silane-coupling agent for the purpose of improving the dispersibility of the fine particles. Silane coupling agents having a coupling site as well as an organic functional group [e.g., vinyl group, amino group (primary to tertiary amino group or quaternary ammonium salt group), epoxy group, mercapto group, chloro group, alkyl group, phenyl group, ester group, or the like] may be used favorably.

In addition, the ink receiving layer according to the invention (coating solution for ink receiving layer) preferably contains a surfactant. The surfactant may be selected suitably from nonionic, ampholytic, anionic, cationic, fluorinated, and siliconated surfactants. The surfactants may be used alone or in combination of two or more.

Examples of the anionic surfactants include aliphatic acid salts (e.g., sodium stearate, potassium oleate), alkyl sulfate ester salts (e.g., sodium lauryl sulfate, triethylammonium lauryl sulfate), sulfonate salts (e.g., sodium dodecylbenzenesulfonate), alkyl sulfosuccinate salts (e.g., sodium dioctyl sulfosuccinate), alkyl diphenyletherdisulfonate salts, alkyl phosphate salts, and the like.

Examples of the cationic surfactants include alkylamine salts, quaternary ammonium salts, pyridinium salts, imidazolium salts, and the like.

Examples of the nonionic surfactants include polyoxyalkylene alkylethers and polyoxyalkylene alkylphenyl ethers (e.g., diethylene glycol monoethylether, diethylene glycol diethylether, polyoxyethylene laurylether, polyoxyethylene stearylether, polyoxyethylene nonylphenylether, and the like); oxyethylene-oxypropylene block copolymers; sorbitan aliphatic esters (e.g., sorbitan monolaurate, sorbitan monooleate, sorbitan trioleate, and the like); polyoxyethylene sorbitan aliphatic esters (e.g., polyoxyethylene sorbitan monolaurate, polyoxyethylene sorbitan monooleate, polyoxyethylene sorbitan trioleate, and the like); polyoxyethylene sorbitol aliphatic esters (e.g., polyoxyethylene sorbit tetraoleate and the like); glycerin aliphatic esters (e.g., glycerol monooleate and the like); polyoxyethylene glycerin aliphatic esters (polyoxyethylene glycerol monostearate, polyoxyethylene glycerol monooleate, and the like); polyoxyethylene aliphatic esters (polyethylene glycol monolaurate, polyethylene glycol monooleate, and the like); polyoxyethylene alkylamines; acetylene glycols (e.g., 2,4,7,9-tetramethyl-5-decyne-4,7-diol, ethylene oxide and propylene oxide adducts of the diol, and the like); and the like. Polyoxyalkylene alkylethers are preferable. The nonionic surfactant may be contained either in the coating solution for ink receiving layer (first solution) or the basic solution (second solution). The nonionic surfactants may be used alone or in combination of two or more.

The amphoteric surfactants include amino acid-type, carboxy ammonium betaine-type, sulfone ammonium betaine-type, ammonium sulfate ester betaine-type, imidazolium betaine-type, and other surfactants. For example, the amphoteric surfactants described in U.S. Pat. No. 3,843,368, JP-A Nos. 59-49535, 63-236546, 5-303205, 8-262742, and 10-282619, and the like may be favorably used. Amino acid-type amphoteric surfactants are preferable as the amphoteric surfactant. Examples of the amino acid-type amphoteric surfactants include those described in JP-A No. 5-303205, i.e., N-acylamino acids having a long chain acyl group and the salts thereof, which are induced from amino acids (glycine, glutamic acid, histidine, and the like). These amphoteric surfactants may be used alone or in combination of two or more.

The fluorinated surfactants include compounds prepared via an intermediumte having a perfluoroalkyl group by means of electrolytic fluorination, telomerization, oligomerization or the like. Example of these compounds include perfluoroalkyl sulfonate salts, perfluoroalkyl carboxylate salts, perfluoroalkyl ethylene oxide adducts, perfluoroalkyltrialkylammonium salt, perfluoroalkyl group-containing oligomers, perfluoroalkyl phosphate esters, and the like.

Silicone oils modified with organic groups are preferable as the siliconated surfactant. The siliconated surfactants may have a siloxane structural unit having the side-chain modified with an organic group, or one or both ends of the surfactant modified therewith. The organic group modification includes amino modification, polyether modification, epoxy modification, carboxyl modification, carbinol modification, alkyl modification, aralkyl modification, phenol modification, fluorine modification, and the like.

The content of the surfactant in the coating solution for ink receiving layer is preferably 0.001 to 2.0% and more preferably 0.01 to 1.0% by mass. If two or more coating solutions for the ink receiving layer are used for coating, each of the coating solutions preferably contains the surfactant.

According to the invention, the ink receiving layer preferably contains a high-boiling point organic solvent for prevention of curling. The high-boiling point organic solvent is preferably a water-soluble or hydrophobic organic compound having a boiling point of 150° C. or more under atmospheric pressure. The organic compound may be liquid or solid at room temperature, and may be a low-molecular weight compound or a polymer.

Specific examples thereof include aromatic carboxylate esters (e.g., dibutyl phthalate, diphenyl phthalate, phenyl benzoate, and the like), aliphatic carboxylate esters (e.g., dioctyl adipate, dibutyl sebacate, methyl stearate, dibutyl maleate, dibutyl fumalate, triethyl acetylcitrate, and the like), phosphate esters (e.g., trioctyl phosphate, tricresyl phosphate, and the like), epoxy compounds (e.g., epoxidized soy bean oil, epoxidized aliphatic acid methyl esters, and the like), alcohols (e.g., stearyl alcohol, ethylene glycol, propylene glycol, diethylene glycol, triethylene glycol, glycerol, diethylene glycol monobutylether (DEGMBE), triethylene glycol monobutylether, glycerin monomethyether, 1,2,3-butanetriol, 1,2,4-butanetriol, 1,2,4-pentanetriol, 1,2,6-hexanetriol, thiodiglycol, triethanolamine, polyethylene glycol, and the like), vegetable oils (e.g., soy bean oil, sunflower seed oil, and the like), higher aliphatic carboxylic acids (e.g., linoleic acid, oleic acid, and the like), and the like.

<Production of an Ink Jet Recording Medium>

Production of an ink jet recording medium in the invention may include forming an ink receiving layer constituting the medium by a process (the Wet on Wet process) that involves first adding an additive to one or both of a coating solution (a first solution) for the ink receiving layer containing at least particulates and a water-soluble resin and a basic solution (a second solution) and at the same time forming a coated layer by application of the above coating solution (the first solution) to the ink solvent permeable undercoat layer of the support, imparting the above basic solution (the second solution) having a pH of 7.1 or more to the above coated layer, (1) when the above coating solution is applied to form the coated layer, or (2) before the coating layer indicates the decreasing rate of drying during the drying of the coated layer formed by application of the above coating solution (the first solution), to crosslink and cure the above coated layer; and subsequently include applying a coating solution for a gloss imparting layer to the formed ink receiving layer and drying the resulting medium.

As described above, the addition of a dye mordant to the second solution may form an ink jet recording medium by means of an arbitrary process such as (1) a process that involves forming a coated layer (with the first solution) containing particulates, a water-soluble resin and a crosslinking resin, and then applying the solution containing a dye mordant (the second solution) thereto, or (2) a process that involves multi-layer applying a coating solution (the first solution) containing particulates and a water-soluble resin and a dye mordant-containing solution (the second solution). This enables the presence of a large amount of dye mordant near the surface of an ink receiving layer, thereby sufficiently mordanting the color material of an ink to be capable of improving the water resistance of recorded letters and images.

Furthermore, the presence of a large amount of a dye mordant in a specified portion of an ink receiving layer can also improve the color concentration, ink oozing with time, gloss of printed portions, the water resistance of letters and images after printing, and ozone resistance. Part of a dye mordant may be contained in the first solution; in the case dye mordants of the first and second solutions may be the same, or different.

Hereinafter, an example of preparing the first solution, i.e., a coating solution containing a vapor-phase process silica, polyvinyl alcohol, a boron compound and a cationic polymer, will be described below.

First, a vapor-phase process silica and a cationic polymer are added in water (e.g., 10 to 20% by mass), and the resulting mixture is dispersed, for example, at a high-velocity of 10,000 rpm (preferably 5,000 to 20,000 rpm) for 20 minutes (preferably 10 to 30 minutes) by using a high-velocity wet colloid mill (e.g., trade name: CLEARMIX, manufactured by M technique Co., Ltd.), into fine particles dispersion. Then, an aqueous solution containing a boron compound and polyvinyl alcohol is added to the fine particles dispersion (e.g., to a concentration of the silica therein of about ⅓), and the resulting solution is dispersed under the same condition as above. The coating solution thus obtained is a homogeneous sol. A porous ink receiving layer having a three-dimensional network structure is formed by applying the coating solution onto a support according to the following coating method. A pH adjusting agent, other dispersant, surfactant, antifoam agent, anti-static agent, or the like may be added to the first solution if necessary.

Water, an organic solvent, or a mixed solvent thereof may be used as the solvent for preparing the first and second solutions. Examples of the organic solvents include alcohols such as methanol, ethanol, n-propanol, i-propanol, and methoxypropanol; ketones such as acetone and methylethylketone; tetrahydrofuran; acetonitrile; ethyl acetate; toluene; and the like.

The first solution (coating solution for ink receiving layer) may be coated by any one of the methods known in the art, for example, by using an extrusion die coater, air doctor coater, blade coater, rod coater, knife coater, squeeze coater, reverse roll coater, bar coater, or the like.

The second solution (basic solution) is applied simultaneously with or after the application of first solution (coating solution for ink receiving layer). The second solution may be applied before the coated layer exhibits falling dry rate when dried. Namely, the ink receiving layer may be favorably formed by introducing the basic solution during the coated layer exhibits constant-rate drying after application of the coating solution for ink receiving layer. The second solution may contain a mordant.

Here, the phrase “before the coated layer exhibits falling dry rate when dried” indicates a period of several minutes after application of the coating solution for ink receiving layer, wherein the content of the solvent (dispersion medium) in the coated layer decreases over time in the manner of “constant-rate drying”. The period of this “constant-rate drying” is described in, for example, Chemical Engineering Handbook (pp.707 to 712, published by Maruzen Co., Ltd., Oct. 25, 1980).

As described above, the coated layer after application of the first solution is dried commonly at 40 to 180° C. for 0.5 to 10 minutes (preferably, 0.5 to 5 minutes) until the coated layer exhibits falling dry rate. The drying period of course varies according to the amount coated, but is commonly in the above range.

Processes that impart the second solution prior to the indication of the decreasing rate of drying include (1) a process of coating the second solution to a coated layer, (2) a process of, for example, spraying, (3) a process of immersing a support on which the coated layer is formed in the second solution, and other processes.

With respect to the method (i), the coating method of applying the second solution may be any one of coating methods known in the art such as those using a curtain flow coater, extrusion die coater, air doctor coater, blade coater, rod coater, knife coater, squeeze coater, reverse roll coater, bar coater, and the like. Among them, a coating method whereby the coater does not brought into direct contact with the first coated layer, such as that using an extrusion die coater, curtain flow coater, bar coater or the like, may be preferably used.

The amount of impartation of the second solution is generally from 5 to 50 g/m², preferably from 10 to 30 g/m².

When the basic solution (second solution) is preferably applied simultaneously with the coating solution for ink receiving layer (first solution), the first and second solutions may be simultaneously applied onto the support (multi-layer application) and then dried, to form an ink receiving layer. In such a case, the first solution is applied directly onto the support.

The simultaneous application (multi-layer application) may be performed by the coating method using, for example, an extrusion die coater or curtain flow coater. The coated layers formed after the simultaneous application is then dried. The coated layers in such a case are commonly dried by heating at 40 to 150° C. for 0.5 to 10 minutes, preferably, at 40 to 100° C. for 0.5 to 5 minutes.

When the simultaneous application (multi-layer application) is performed, for example, by using an extrusion die coater, two kinds of liquids simultaneously extruded are laminated in the neighborhood of the outlet of the extrusion die coater, i.e., before the liquids are applied onto the support, and applied onto the support as it is. The two layers of coating solutions laminated before application tend to make a crosslinking reaction at the interface of the two solutions before they are applied onto the support, often causing increase in viscosity due to mixing of the two solutions at the neighborhood of the extrusion die coater and sometimes causing troubles in the application operation. Therefore, during the simultaneous application, it is preferable to add a barrier-layer solution (intermediumte-layer solution) between the first and second solutions (simultaneous three-layer application).

The barrier-layer solution is not particularly limited, and examples thereof include an aqueous solution containing a trace amount of water-soluble resins, water, and the like. The water-soluble resins are used considering the coating property of the solution, for example, for increasing the viscosity of the solution, and examples thereof are polymers including cellulosic resins (e.g., hydroxypropylmethylcellulose, methylcellulose, hydroxyethylmethylcellulose, and the like), polyvinylpyrrolidone, gelatin, and the like. The barrier-layer solution may contain a mordant.

After the formation of an ink receiving layer on a support, an ink jet recording medium may be produced by the application of a gloss imparting layer coating solution to the surface of an ink receiving layer. In the above gloss imparting layer coating solution are contained at least the aforementioned superfine inorganic compound and the aforementioned water-soluble resin. At this time, a crosslinking agent may be added to the above gloss imparting layer coating solution, or may be contained in an ink receiving layer coating solution. Even when a crosslinking agent is added to an ink receiving layer coating solution, after the formation of an ink receiving layer, the application of a gloss imparting layer coating solution to the surface thereof makes it possible to contain the crosslinking agent in the gloss imparting layer on account of the diffusion of the crosslinking agent in the ink receiving layer to the gloss imparting layer. In addition, when a crosslinking agent is made to be contained in an ink receiving layer coating solution, the crosslinking agent is preferably added to the above-described second solution.

When a crosslinking agent is added to an ink receiving layer coating solution, the use of different kinds of water-soluble resins are used for a gloss imparting layer and the ink receiving layer requires adding croslinking agents corresponding them, for example, to the above second solution in some cases, and thus water-soluble resins used in a gloss imparting layer and an ink receiving layer are preferably the same kind.

A solvent used in the above gloss imparting layer coating solution may be selected as appropriate from the abovementioned solvents for use. The formation process of a gloss imparting layer is not particularly limited, and the above-described process or the like may be as appropriated used for the formation.

The above gloss imparting layer enables improved surface evenness, glossness, transparency and coated layer strength for example by means of a soft calender, a super calender, a gloss calender, or the like, by calendar treatment of passing through the roll nips under heat applied and pressurized conditions.

After the above gloss imparting layer formation, the resulting gloss imparting layer is generally heated at from 40 to 180° C. for from 0.5 to 10 minutes and dried and cured. Preferably, the layer is heated at from 40 to 150° C. for 1 to 5 minutes. For instance, when a crosslinking agent contained in the first solution is boric acid or a boron compound (borax, etc.), the layer is preferably heated at from 60 to 100° C. for from 3 to 5 minutes.

The roll temperature for the conduct of the above calender treatment is preferably from 30 to 150° C., more preferably from 40 to 100° C. The linear pressure between the rolls during calender treatment is preferably from 50 to 400 kg/cm, more preferably from 100 to 200 kg/cm.

In the case of ink jet recording, the thickness of the ink receiving layer should be decided according to the void percentage of the layer, as the layer should have a sufficient absorption capacity allowing absorption of all droplets. For example, if the ink quantity is 8 nL/mm2 and the void percentage is 60%, a film having a thickness of about 15 μm or more is required. Considering the above, ink receiving layer for ink jet recording preferably have a thickness of 10 to 50 μm.

In addition, the diameter of the voids in the ink receiving layer is preferably 0.005 to 0.030 μm as a medium size, and more preferably 0.01 to 0.025 μm. The void percentage and the void mediumn size may be determined by using a mercury porosimeter (trade name: “Poresizer 9320-PC2”, manufactured by Shimadzu Corporation).

The ink receiving layer is preferably higher in transparency, and the haze value, an indicator of transparency, of the ink receiving layer formed on a transparent film support is preferably 30% or less and more preferably 20% or less. The haze value may be determined by using a hazemeter (trade name: HGM-2DP, manufactured by Suga Test Instrument Co., Ltd.).

### EXAMPLES

Hereinafter, the present invention will be specifically set forth in terms of Examples; however, the invention is by no means limited to the Examples. Also, in the Examples an ink jet recording sheet is fabricated as an example of ink jet recording media; “parts” and “%” in the Examples are by mass unless otherwise indicated and the average molecular weight and the degree of polymerization represent respectively the “weight average molecular weight” and the “weight average polymerization degree.”

### Example 1

Fabrication of Support A

1) Fabrication of Base Paper

Wood pulp made of 100 parts of LBKP was beaten by a double disk refiner to 300 ml of Canadian freeness and thereto were added 0.5 part of epoxidized amide behenate, 1.0 part of the polyacryl amide anion, 0.1 part of polyamide-polyamine-epichlorohydrin and 0.5 part of the polyacrylamide cation each by absolute mass ratio based on the amount of pulp and then 170 g/m² of base paper was made by Fourdrinier paper machine weight determination. Then, 0.04% of a fluorescent brightening agent (Whitex BB (trade name), manufactured by Sumitomo Chemical Co., Ltd.) was added to 4% aqueous polyvinyl alcohol solution for the adjustment of the surface size of the above base paper; the resulting solution was impregnated into the above base paper in such a way that the absolute weight concentration was 0.5 g/m²; the resultant base paper was dried and then a base paper having a density of 1.05 g/cm³ was obtained by calender treatment.

2) Preparation of the Coating Solution for Ink Solvent Absorptive Undercoat Layer

First, 100 parts of titanium dioxide (trade name: TIPAQUER-780-2, manufactured by ISHIHARA SANGYO KAISHA, LTD.), 1.2 parts of a 25% solution containing sodium salt of a special polycarboxylic acid-based polymer (trade name: Demol EP, manufactured by Kao Corp.), and 121.7 parts of water were mixed, and the resulting mixture was dispersed in NBK-2 (manufactured by NIPPON SEKI Co., Ltd.) to prepare a 45% titanium dioxide dispersion. Subsequently, 100 parts of a 35% aqueous acrylic latex dispersion (glass transition temperature: 60° C.; minimum layer forming temperature: 50° C.; trade name: Aquabrid 4635, manufacture by DAICEL CHEMICAL INDUSTRIES, LTD.), 43 parts of water, and 35 parts of the 45% titanium dioxide dispersion thus obtained were mixed and stirred well. After stirring, the temperature of the solution was kept at 15 to 25° C., to obtain a 28.6% coating solution for the ink solvent absorptive undercoat layer.

3) Formation of an Ink Solvent Permeable Undercoat Layer

To the felt face (surface) side of the base paper obtained in 1) above was applied the ink solvent permeable undercoat layer coating solution obtained in 2) above with a bar coater in such a way that a dried coated amount was 15 g/m², and dried, thereby obtaining an ink solvent permeable undercoat layer (hereinafter, the face on which the ink solvent permeable undercoat layer was formed is called the “front face.”). Then, to the front face and the wire face (i.e., the face on which the ink solvent permeable undercoat layer was not formed) of the back side, of the base paper, was applied an ink solvent permeable undercoat layer coating solution as mentioned above with a bar coater in such a way that a dried coated amount was 25 g/m², and dried, thereby producing a curl adjusting layer (hereinafter, the face on which the curl adjusting layer was formed is called the “back face.”).

4) Soft Calender Treatment

The base paper having an ink solvent permeable undercoat layer and a curl adjusting layer was subjected to soft calender treatment by means of a soft calender having a pair of a metal roll and a resin roll at a surface temperature of the metal roll of 80° C., a nip pressure of 200 kg/cm, and a speed of 100 m/min, thereby making a support (hereinafter, called “support A”).

Fabrication of a Sheet for an Ink Jet Recording

1) Preparation of a Coating Solution for an Ink Receiving Layer

(1) The silica particulates prepared by the gas phase process, (2) the ion exchanged water and (3) the dispersing agent, as described in the composition below, were dispersed with a dispersing machine (KD-P (trade name), manufactured by Sinmal Enterprises Corp.), thereby producing a silica dispersed solution, and then to the above silica dispersed solution was added an aqueous solution prepared by dissolution of (7) the ion exchanged water, (4) the polyvinyl alcohol, (5) the boric acid and (6) the polyoxyethylene lauryl ether, thereby preparing a coating solution for an ink receiving layer. At this time, the weight ratio of the particulates to the water-soluble resin (PB ratio=(1):(4)) is 4.5:1 and the ink receiving layer coating solution was acidic, at a pH of 3.5.

<Composition of the Ink Receiving Layer Coating Solution>

| | |
|---|---|
| (1) Silica particulates prepared by the gas phase process | 10.0 parts |
| (particulates) (Leoroseal QS-30 (trade name), average | |
| primary particle diameter 7 nm, manufactured by | |
| Tokuyama Corp.) | |
| (2) Ion exchanged water | 51.6 parts |
| (3) Dispersing agent | 1.0 part |
| (SharollDC-902P (trade name), 51% aqueous solution, | |
| manufactured by Nitto Boseki Co., Ltd.) | |
| (4) Polyvinyl alcohol (water-soluble resin) 8% aqueous | 27.8 parts |
| solution (PVA-124 (trade name), manufactured by | |
| Kuraray Co., Ltd., saponification percent | |
| 98.5%, polymerization degree 2400) | |
| (5) Boric acid (crosslinking agent) | 0.4 part |
| (6) Polyoxyethylene lauryl ether (surfactant) | 1.2 parts |
| (Emulgen 109P (trade name), 10% aqueous solution, | |
| manufactured by Kao Corp., HLB value 13.6) | |
| (7) Ion exchanged water | 33.0 parts |

2) Formation of an Ink Receiving Layer

To the front face of support A obtained as described above was applied the resulting ink receiving layer coating solution with an extrusion die coater in an application amount of 200 ml/M² and the resultant support was dried at 80° C. in a hot air drying machine (air speed of from 3 to 8 m/sec) until the solid component concentration of the coated layer was 20%. During this period of time, the coated layer indicated the constant rate of drying. Immediately after this, the support was immersed in a basic solution, as described below, for 30 seconds, whereby an amount of 20 g/m² of the solution was adhered to the coated layer, and then the resulting layer was dried at 80° C. for 10 minutes. This procedure formed an ink receiving layer having a dried layer thickness of 32 μm.

<Composition of a Basic Solution>

| | |
|---|---|
| Boric acid (crosslinking agent) | 0.65 part |
| Polyallylamine | 12.5 parts |
| (PAA-03 (trade name), 20% aqueous solution, manufactured | |
| by Nitto Boseki Co., Ltd.; dye mordant) | |
| Ion exchanged water | 72.0 parts |
| Ammonium chloride (surface pH adjusting agent) | 0.8 part |
| Polyoxyethylene lauryl ether (surfactant) | 10 parts |
| (Emulgen 109P (trade name), 2% aqueous solution, | |
| HLB value 13.6, manufactured by Kao Corp.) | |
| Fluorine-based surfactant | 2.0 parts |
| (Megafack F1405 (trade name), 10% aqueous solution, | |
| manufactured by Dainippon Ink And Chemicals, Inc.) | |

3) Preparation of a Coating Solution for a Gloss Imparting Layer

Mixed were (1) the superfine titanium dioxide dispersed solution, (2) the polyvinyl alcohol and (3) the ion exchanged water, as described in the composition below. Subsequently, (4) the boric acid and (5) the polyoxyethylene lauryl ether were added thereto, thereby preparing an ink receiving layer coating solution. At this time the weight ratio of the superfine titanium dioxide dispersed solution to the polyvinyl alcohol (PB ratio=(1):(2)) was 5:1, with the application amount of the above superfine particle titanium dioxide being 1.0 g/m² and the concentration of the above gloss imparting layer coating solution being 5.9%.

<Composition of a Coating Solution for a Gloss Imparting Layer>

| | |
|---|---|
| (1) Superfine particle titanium dioxide | 100 parts |
| (ELCOM-P (trade name), 20% dispersed solution, refractive | |
| index 2.5, manufactured by Catalyst & Chemicals Ind. Co., | |
| Ltd., average particle diameter 8 nm) | |
| (2) Polyvinyl alcohol (water-soluble resin) | 50 parts |
| (PVA124 (trade name), 8% aqueous solution, manufactured | |
| by Kuraray Co., Ltd., saponification percent 98.5%, | |
| polymerization degree 2400) | |
| (3) Ion exchanged water | 268 parts |
| (4) Boric acid (crosslinking agent) | 0.7 part |
| (5) Polyoxyethylene lauryl ether (surfactant) | 1.2 parts |
| (Emulgen 109P (trade name), 10% aqueous solution, HLB | |
| value 13.6, manufactured by Kao Corp.) | |

4) Formation of a Gloss Imparting Layer

To the ink receiving layer obtained as in 2) above was applied the gloss imparting layer coating solution obtained as in 3) above with a bar coater in such a way that a dried coated amount of the layer was 1 g/m², and the resulting layer was dried at 80° C. for 1 minute, thereby forming a gloss imparting layer. This procedure fabricated an ink jet recording sheet having a dried layer thickness of 33 μm of the invention.

### Example 2

An ink jet recording sheet of the invention was fabricated as in Example 1 except that 100 parts of a 35% aqueous acrylic silicone-based latex dispersed solution (Aquabrid Asi-91 (trade name), manufactured by Daicel Chemical Industries, Ltd.: glass transition temperature 25° C., the lowest layer forming temperature 20° C.) was added instead of “a 35% aqueous acrylic silicone-based latex dispersed solution” (Aquabrid 4635 (trade name), manufactured by Daicel Chemical Industries, Ltd.: glass transition temperature 60° C., the lowest layer forming temperature 50° C. in ”2) Preparation of a Coating Solution for Ink Solvent Permeable Undercoating,” in “Fabrication of Support A” of Example 1.

### Example 3

An ink jet recording sheet was fabricated as in Example 1 except that (3) 4048 parts of ion exchanged water was added in place of “(3) 268 parts of (3) ion exchanged water” in “3) Formation of an Ink Solvent Permeable Undercoat Layer” in “Fabrication of an Ink Jet Recording Sheet” of Example 1. At this time, the weight ratio of the particulate titanium dioxide dispersed solution to the polyvinyl alcohol (PB ratio=(1):(2)) was 5:1. In addition, the amount of application of the above particulate titanium dioxide was 0.1 g/m² and the concentration of the above gloss imparting coating solution was 0.6%.

### Example 4

An ink jet recording sheet was fabricated as in Example 1 except that (3) 58 parts of ion exchanged water was added in place of “(3) 268 parts of ion exchanged water” in “3) Formation of an Ink Solvent Permeable Undercoat Layer” in “Fabrication of an Ink Jet Recording Sheet” of Example 1. At this time, the weight ratio of the particulate titanium dioxide dispersed solution to the polyvinyl alcohol (PB ratio=(1):(2)) was 5:1. In addition, the amount of application of the above particulate titanium dioxide was 2 g/m² and the concentration of the above gloss imparting coating solution was 11.8%.

### Example 5

An ink jet recording sheet was fabricated as in Example 1 except that (3) 35 parts of ion exchanged water was added in place of “(3) 268 parts of ion exchanged water” in “3) Formation of an Ink Solvent Permeable Undercoat Layer” in “Fabrication of an Ink Jet Recording Sheet” of Example 1. At this time, the weight ratio of the particulate titanium dioxide dispersed solution to the polyvinyl alcohol (PB ratio=(1):(2)) was 5:1. In addition, the amount of application of the above particulate titanium dioxide was 3.0 g/ m² and the concentration of the above gloss imparting coating solution was 13.3%.

### Example 6

An ink jet recording sheet was fabricated as in Example 1 except that 40 parts of a 35% styrene-butadiene-based latex water-dispersed solution (0696 (trade name), manufactured by JSR Corp.): glass transition temperature 40° C. and 10 parts of a 35% acrylic urethane-based latex water-dispersed solution (Aqurit WEM-321U (trade name), manufactured by Taisei Kako Co., Ltd.: glass transition temperature 20° C.) and 40 parts of a 35% acrylic styrene-based latex water-dispersed solution (Aquabrid 4970 (trade name), manufactured by Daicel Chemical Industries, Ltd.: glass transition temperature 25° C., the lowest layer forming temperature 30° C.) in place of “a 35% acrylic latex water-dispersed solution (Aquabrid 4635 (trade name), manufactured by Daicel Chemical Industries, Ltd.: glass transition temperature 60° C., the lowest layer forming temperature 50° C.)” in “2) Preparation of a Coating Solution for an Ink Solvent Permeable Undercoating” in “Fabrication of Support A” of Example 1.

### Example 7

An ink jet recording sheet was fabricated as in Example 1 except that 100 parts of superfine particle zirconia (Zirconia NZS-30A (trade name), manufactured by Nissan Chemical Industries, Ltd.: 20% dispersed solution, average particle diameter 60 nm, refractive index 2.0) was added in place of “superfine particle titanium dioxide (ELCOM-P (trade name), manufactured by Catalyst & Chemicals Ind. Co., Ltd., 20% dusoersed solution, average particle diameter 8 nm, refractive index 2.5)” in “3) Formation of an Ink Solvent Permeable Undercoat Layer” in “Fabrication of an Ink Jet Recording Sheet” of Example 1. At this time, the weight ratio of the superfine particle zirconia dispersed solution to the polyvinyl alcohol (PB ratio=(1):(2)) was 5:1. In addition, the amount of application of the above superfine particulate titanium dioxide was 3.0 g/m² and the concentration of the above gloss imparting coating solution was 13.3%.

### Comparative Example 1

An ink jet recording sheet for comparison was fabricated as in Example 1 except that “the gloss imparting layer” in “Fabrication of an Ink Jet Recording Sheet” of Example 1 was not formed.

### Comparative Example 2

An ink jet recording sheet for comparison was fabricated as in Example 1 in “3) Preparation of a Coating Solution for a Gloss Imparting Layer” in “Fabrication of an Ink Jet Recording Sheet” of Example 1 except that (1) 100 parts of the 20% superfine particle titanium dioxide dispersed solution was not used and that (2) 150 parts of 8% polyvinyl alcohol and (3) 57 parts of ion exchanged water were mixed and then (4) 2.2 parts of boric acid and (5) 0.7 part of polyoxyethylene lauryl ether were added thereto. At this time, the amount of application of the superfine particle titanium dioxide was 0 g/m². The amount of application of the polyvinyl alcohol was 1.2 g/m² and the concentration of the above gloss imparting coating solution was 6.8%.

### Example 8

Fabrication of Support B

1) Fabrication of Base Paper

Wood pulp made of 100 parts of LBKP was beaten by a double disk refiner to 300 ml of Canadian freeness and thereto were added 0.5 part of epoxidized amide behenate, 1.0 part of the polyacryl amide anion, 0.1 part of polyamide-polyamine-epichlorohydrin and 0.5 part of the cation polyacrylamide each by absolute weight ratio based on the amount of pulp and then 170 g/m² of base paper was sheet made by Fourdrinier paper machine weight determination. Then, 0.04% of a fluorescent brightening agent (Whitex BB (trade name), manufactured by Sumitomo Chemical Co., Ltd.) was added to 4% aqueous polyvinyl alcohol solution for the adjustment of the surface size of the above base paper; the resulting solution was impregnated into the above base paper in such a way that the absolute weight concentration was 0.5 g/m²; the resultant base paper was dried and then a base paper having a density of 1.05 g/cm³ was obtained by calender treatment.

After the wire face (back face) of the base paper thus obtained was subjected to corona discharge treatment, the back face was coated so that the thickness of high density polyethylene became 19 μm by a melt extruder, whereby a resin layer comprising a mat face was formed (hereinafter, the resin layer face is referred to as the “back face.”). The resin layer of the back face side was additionally subjected to corona discharge treatment, and subsequently a dispersed solution as an antistat prepared by dispersion of aluminum oxide (ALUMINA SOL 100 (trade name), manufactured by Nissan Chemical Industries, Ltd.) and silicon dioxide (SNOWTEX ◯, manufactured by Nissan Chemical Industries, Ltd.) in a 1:2 weight ratio in water was applied thereto such that a dried weight of the layer was 0.2 g/m².

After the felt side (front face) without having a resin layer was subjected to corona discharge treatment, the surface side of the base paper (hereinafter, the high gloss face is referred to as the “front face.”) was coated with a high gloss thermoplastic resin layer in such a way that the thickness of the thermoplastic resin layer became 29 μm; the thermoplastic resin layer was produced by extrusion of low-density polyethylene with an MFR (melt flow rate) of 3.8 containing therein a 10% anatase type titanium dioxide, a trace amount of an ultramarine blue pigment and a 0.01% fluorescent brightening agent (relative to polyethylene); as a result, support B was fabricated.

Fabrication of an Ink Jet Recording Sheet

The front face of support B not having an ink solvent permeable undercoat layer and having a gloss face was subjected to corona discharge treatment, and then an ink receiving layer and a gloss imparting layer were formed as in Example 1, thereby fabricating an ink jet recording sheet of the invention.

### Comparative Example 3

An ink jet recording sheet for comparison was fabricated as in Example 8 except that the gloss imparting layer was not formed in the fabrication of the ink jet recording sheet of Example 8.

<Evaluation>

The ink jet recording sheets of the invention and for comparison obtained as described above were subjected to the evaluation testing below. The results are summarized in Table 1 below.

(1) Glossness

The blank portions of the ink jet recording sheets were determined for glossness values at an incidence angle of 600 and a light receiving angle of 600 by means of a digital varying-angle photometer (UGV-5D (trade name, manufactured by Suga Test Instruments Co., Ltd.) in accordance to JIS Z8741 (1997); the values were evaluated according to the criteria below.

Criteria

A: the glossness value is 50% or more.
B: the glossness value is from 40% inclusive to 50% exclusive.
C: the grossness value is from 30% inclusive to 40% exclusive.
D: the glossness value is less than 30%.
   (2) Image Clarity (Gloss Feeling)

The blank portions of the ink jet recording sheets were determined for the C values under the conditions of an incidence angle of 60°, a light receiving angle of 60° and an optical comb width of 2.0 mm by means of an image clarity measuring machine (ICM-IT (trade name), manufactured by Suga Test Instruments Co., Ltd.) in accordance to JIS H8686-2 (1999); the values as indexes of gloss feeling were evaluated according to the criteria below.
A: the C value is 85% or more.
B: the C value is from 60 to 85%.
C: the C value is from 40 to 60%.
D: the C value is 40% or less.
   (3) Ink Absorbing Speed

Solid images of Y (yellow), M (magenta), C (cyan), K (black), B (blue), G (green) and R (red) were printed on each ink jet recording sheet by means of an ink jet printer (PM-970C (trade name), manufactured by Seiko Epson Corp.). A piece of paper was pressed onto the images formed immediately after their printing (about after 10 seconds); the presence or absence of the transcription of the above image ink into the paper was visually observed, whereby the transcription was evaluated in accordance with the criteria below.

Criteria

A: Completely no transcription of ink into a piece of paper was observed (Absorption of ink is good.).
B: Slight transcription of ink into a piece of paper was observed (Absorption of ink is slightly poor.).
C: Transcription of ink into a piece of paper was observed (Absorption of ink is poor.).
   (4) Image Quality Evaluation

Images of a person and scenery were printed on each ink jet recording sheet by an ink jet printer (PM-970C (trade name), manufactured by Seiko Epson Corp.); the image quality was visually evaluated in accordance with the criteria below.

Criteria

A: Image quality is excellent in clearness.
B: Image quality is good.
C: Image quality is insufficient even though it is practically allowable.
D: Image quality is poor.
   (5) Evaluation of Oozing with Time

A lattice-like linear pattern (line width: 0.28 mm) produced by alignment of lines of magenta ink and black ink side by side was printed on each ink jet recording sheet by an ink jet printer (PM-970C (trade name), manufactured by Seiko Epson Corp.) and the resulting pattern was determined for the visual concentration (OD₀) by means of a visual concentration meter (X Light 310TR (trade name), manufactured by X Light Corp.). Thereafter, the pattern was allowed to stand for 3 hours after the printing, and then the pattern was stored for one day in a thermo-hygrostat having a temperature of 40° C. and a relative humidity of 90%. After storage, the visual concentration (OD₀) was determined again by the visual concentration meter; the concentration was evaluated on the basis of the concentration difference (ΔOD=OD₀−OD₁) in accordance with the criteria below. The smaller the concentration difference ΔOD, the more restrained the generation of bleeding with time.
A: ΔOD is 0.15 or less.
B: ΔOD is from 0.15 to 0.25, both exclusive.

C: ΔOD is 0.25 or more.

TABLE 1

| | | | Ink | | Bleeding |
|---|---|---|---|---|---|
| | Gloss- | Image Clarity | Absorbing | Image | with |
| | ness | (Gloss Feeling) | Speed | Quality | Time |
| Example 1 | A | A | A | A | A |
| Example 2 | A | A | A | A | A |
| Example 3 | A | B | A | A | A |
| Example 4 | A | A | A | A | A |
| Example 5 | A | A | B | A | A |
| Example 6 | A | A | A | A | A |
| Example 7 | A | A | A | A | A |
| Comparative | D | C | A | B | A |
| Example 1 | | | | | |
| Comparative | B | C | C | D | A |
| Example 2 | | | | | |
| Example 8 | A | A | A | A | B |
| Comparative | C | B | A | A | C |
| Example 3 | | | | | |

Table 1 above shows that the ink jet recording sheets, each having a gloss imparting layer, of Examples 1 to 7, can exhibit high gloss feeling although the sheets are composed of a paper substrate. The sheet of Example 8 by use of a support composed of polyethylene resin coated paper can offer still higher gloss properties. The ink jet recording sheets, each having an ink solvent permeable undercoat layer on its paper substrate, of Examples 1 to 7, effectively restrain the generation of oozing with time. The ink jet recording sheets, each having titanium dioxide and zirconia with an application amount of from 0.1 to 2.0 g/m² each, of Examples 1 to 8 have high ink absorption and satisfactory image quality.

On the other hand, the sheet without having a gloss imparting layer of Comparative Example 1 and the sheet without using a superfine particle inorganic compound of Comparative Example 2 have extremely low glossness and gloss feeling. The sheet of Comparative Example 3 using a conventional support, which does not have a gloss imparting layer, which has a paper substrate surface coated with a polyethylene resin, and which does not have an ink solvent permeable undercoat layer, has high gloss and is good in ink absorption and image quality, however, cannot prevent bleeding with time due to the ink solvent remainder.

1. An ink jet recording medium comprising at least both an ink receiving layer and a gloss imparting layer in this order on the support of the ink jet recording medium, wherein
the gloss imparting layer comprises a superfine particle inorganic compound having a refractive index of at least 1.9 and an average particle diameter of 100 nm or less, a water-soluble resin, and a crosslinking agent capable of crosslinking the water-soluble resin.

2. The ink jet recording medium of claim 1, wherein
the thickness of the gloss imparting layer is from 0.1 to 2 μm.

3. The ink jet recording medium of claim 1, wherein
the water-soluble resin of the gloss imparting layer comprises a polyvinyl alcohol-based resin.

4. The ink jet recording medium of claim 1, wherein
the water-soluble resin of the gloss imparting layer is the same kind as the resin used in the ink receiving layer.

5. The ink jet recording medium of claim 1, wherein
the superfine particle inorganic compound of the gloss imparting layer comprises at least one species selected from titanium dioxides and zirconias.

6. The ink jet recording medium of claim 1, wherein
the amount of the superfine particle inorganic compound of the gloss imparting layer to be applied is from 0.1 to 2 g/m².

7. The ink jet recording medium of claim 1, wherein
the content of the superfine particle inorganic compound in the gloss imparting layer is from 5 to 95% by mass.

8. The ink jet recording medium of claim 1, wherein
the superfine particle inorganic compound of the gloss imparting layer comprises a titanium dioxide having an average particle diameter of 20 nm or less.

9. The ink jet recording medium of claim 1, wherein
the crosslinking agent of the gloss imparting layer comprises boric acid or a boron compound.

10. The inkjet recording medium of claim 1, wherein
the support comprises resin coated paper having a resin layer on at least the side on which the ink receiving layer is formed.

11. The ink jet recording medium of claim 1, wherein
the ink receiving layer comprises a water-soluble resin, a crosslinking agent capable of crosslinking the water-soluble resin, particulates, and a dye mordant.

12. The ink jet recording medium of claim 11, wherein
the water-soluble resin of the ink receiving layer comprises at least one species selected from polyvinyl alcohol-based resins, cellulose-based resins, resins having ether bonds, resins having carbamoyl groups, resins having carboxyl groups, and gelatins, and also comprises as particulates at least one species selected from silica particulates, colloidal silica, alumina particulates, and pseudoboehmite.

13. The ink jet recording medium of claim 1, wherein
the ink receiving layer is a layer produced by the crosslink curing of a coated layer formed by the coating of a coating solution containing at least both particulates and a water-soluble resin, and wherein
the crosslink curing comprises adding a crosslinking agent to the coating solution and/or a basic solution having a pH of 7.1 or more, and applying the basic solution to the coated layer either (1) concurrently with the coating of the coating solution to form the coated layer or (2) prior to the coated layer exhibiting a decreasing rate of drying, during drying of the coating solution coated to form the coated layer.

14. An ink jet recording medium comprising at least both an ink receiving layer and a gloss imparting layer in this order on a support comprising:
a paper substrate; and an ink solvent permeable undercoat layer of 2 to 20 g/cm² formed at least on the side of the paper substrate on which the ink receiving layer is formed through the use of a dispersing solution containing therein a thermoplastic resin and a white pigment, wherein
the gloss imparting layer comprises a superfine particle inorganic compound having a refractive index of at least 1.9 and an average particle diameter of 100 nm or less, a water-soluble resin, and a crosslinking agent capable of crosslinking the water-soluble resin.

15. The ink jet recording medium of claim 14, wherein
the thermoplastic resin of the undercoat layer is at least one species selected from an acrylic latex, an acrylic silicone-based latex, an acrylepoxy-based latex, an acrylic styrene-based latex, an acrylic urethane-based latex, a styrene-butadiene-based latex, an acrylonitrile-butadiene-based latex, and a vinyl acetate-based latex.

16. The ink jet recording medium of claim 14, wherein
the thermoplastic resin of the undercoat layer has a glass transition temperature of from 5 to 70° C. and a lowest layer formation temperature of from 5 to 60° C.

17. The ink jet recording medium of claim 14, wherein
the white pigment of the undercoat layer comprises a titanium dioxide having a particle size of from 0.1 to 0.5 μm.

18. The ink jet recording medium of claim 14, wherein
the white pigment of the undercoat layer has a refractive index of 1.5 or more and a specific surface of less than 100 m²/g as determined by the BET method.

19. The ink jet recording medium of claim 14, wherein
the thickness of the undercoat layer is from 0.2 to 5.0 μm.

20. The ink jet recording medium of claim 14, wherein
the support has undergone calender treatment after the formation of the undercoat layer on the paper substrate with a calender in which at least one of a pair of rollers is a metal roller, the surface temperature of the metal roller being equal to or higher than the glass transition temperature of the thermoplastic resin, and the nip pressure of the pair of rollers being 50 to 400 kg/cm.
